(19) United States
(12) Patent Application Publication
(10) Pub. No.: US 2002/0015101 A1
(43) Pub. Date: Feb. 7, 2002

(54) All-electronic high-resolution digital still camera

(76) Inventors: Carver A. Mead, Santa Clara, CA (US); Richard B. Merrill, Woodside, CA (US); Richard F. Lyon, Los Altos, CA (US)

Correspondence Address: Kenneth D'Alessandro, Sierra Patent Group, Ltd., P.O. Box 6149, Stateline, NV, 89449, US

(21) Appl. No.: 09/917,609

(22) Filed: Jul. 27, 2001

Related U.S. Application Data
(60) Provisional application No. 60/222,810, filed on Aug. 4, 2000.

(51) Int. Cl. H04N 5/222

(52) U.S. Cl. 348/333.01

(57) ABSTRACT

An electronic camera system includes a lens system including at least one lens. A semiconductor sensor array having a plurality of pixels is optically coupled to the lens system. Each pixel generates an output signal that is a function of incident light. A sensor control circuit is adapted to produce sensor control signals for controlling the operation of the pixels in the semiconductor sensor array in response to user input. Circuitry is provided for producing from the semiconductor sensor array a first set of image output signals indicative of the intensity of the light at a first set of the pixels when the sensor control signals are in a first state, and a second set of image output signals indicative of the intensity of the light at a second set of the pixels when the sensor control signals are in a second state, the first set of pixels including more pixels than the second set of pixels. A storage medium is coupled to the sensor array and is adapted for storing a representation of the first set of image output signals when the sensor control signals are in the first state. A display is adapted for displaying the second set of image output signals when the sensor control signals are in the second state.

### CROSS-REFERENCE TO RELATED APPLICATIONS

This application claims priority to U.S. Provisional Application Serial No. 60/222,810, filed Aug. 4, 2000.

### BACKGROUND

The present application relates to digital still cameras, and, more particularly, to a new type of all-electronic high-resolution digital still camera.

The simplest form of a prior art digital still camera is illustrated in prior art FIG. 1. Rays of light 10 from a scene to the left of prior art FIG. 1 are focused by primary optical system 12 onto a sensor chip 14. Optical system 12 and sensor chip 14 are housed within light-tight housing 16 to prevent stray light from falling on sensor chip 14 and thereby corrupting the image formed by rays 10. Separate rays of light 18 from the same scene are focused by secondary optical system 20 in such a manner that they can be viewed by the eye 22 of the user of the camera. A light-tight baffle 24 separates the chamber housing sensor chip 14 from secondary optical system 20. The arrangement illustrated in prior art FIG. 1 is identical to that of a box-type film camera, where the film has been replaced by sensor chip 14.

A typical electronic system for prior art digital still cameras represented by prior art FIG. 1, is illustrated in prior art FIG. 2. Output signals from sensor chip 14 are processed by processing electronics 26 and stored on storage medium 28. Sensor chip 14 can be either of the charged-coupled device (CCD) or complementary metallic oxide semiconductor (CMOS) type sensors. Storage medium 28 can be magnetic tape, magnetic disk, semiconductor flash memory, or other types known in the art. Control electronics 30 provide signals for controlling and operating sensor chip 14, processing electronics 26, and storage medium 28. Cameras of this type are generally low-cost fixed-focus point-and-shoot variety, and lack any autofocus mechanism.

A related but slightly more sophisticated prior art camera arrangement is illustrated in prior art FIG. 3. Here, the viewfinder image is derived from primary rays 10 passing through primary optical system 12 by reflecting surfaces 32 and 34, and is then focused by secondary optical system 20 such that it can be viewed by the eye 22 of the user of the camera. A mechanical system, not illustrated, pivots reflecting surface 32 out of the direct optical path to sensor chip 14 when an electronic exposure is desired. The arrangement of prior art FIG. 3 is identical to that of a single-lens reflex type film camera, where, once again, the film has been replaced by the sensor chip.

A typical electronic systems used in the prior art digital still camera illustrated in prior art FIG. 3 is illustrated in prior art FIG. 4. Output signals from sensor chip 14 are processed by processing electronics 26 and stored on storage medium 28. Sensor chip 14 can be either of the CCD or CMOS type. Storage medium 28 can be magnetic tape, magnetic disk, semiconductor flash memory, or other types known in the art. Control electronics 30 provides signals for controlling and operating sensor chip 14, processing electronics 26, and storage medium 28.

Cameras of this type use the same autofocus and autoexposure mechanisms found in corresponding film cameras. Autofocus is completed using secondary mirrors and sensors, which must be precisely aligned. A nice overview of this type of camera design is given in the August 2000 issue of Scientific American. The notable property of such designs is the mechanical complexity involving moving mirrors that must come into re-registration with high precision after swift movement. These highly precise mechanical mechanisms are fragile and prone to malfunction in changing temperature. They are also expensive to manufacture.

The electronic system illustrated in prior art FIG. 4 has a number of elements for operating the autofocus and autoexposure subsystems. Control electronics 30 receives inputs from focus sensor 36 and exposure sensor 38, and generates control signals for energizing actuator 40 for pivoting reflecting surface 32, and for controlling aperture and focus of primary optical system 12. It will be noted that control electronics 30 makes no use of signals derived from sensor 14 in computing control signals for focus and exposure, but must rely on sensors 36 and 38 for these calculations. Accordingly, any deviation between the primary image sensor chip 14 and sensors 36 and 38 will immediately degrade the quality of the image stored in medium 28, because of poor focus, poor exposure, or both. Accordingly, it is desirable to find an all-electronic solution to the viewfinder, autofocus and autoexposure problems, using information generated by primary sensor chip 14, not requiring additional sensors, and thereby obviating the need for mechanical complexity and precise alignment of multiple elements.

A second form of prior art digital still camera is illustrated in prior art FIG. 5. Rays of light 50 from a scene to the left of prior art FIG. 5 are focused by primary optical system 52 onto a sensor chip 54. An electronic system, not illustrated in prior art FIG. 5, and more particularly described in prior art FIG. 7, takes electrical signals from sensor chip 54 and derives electrical signals suitable for driving flat-panel display, which is typically of the liquid-crystal type. Rays of light from flat-panel display are directly viewed by the eye of the user of the camera.

A related design for a digital still camera is illustrated in prior art FIG. 6. Rays of light 50 from a scene to the left of prior art FIG. 5 are focused by primary optical system 52 onto a sensor chip 54. An electronic system, not illustrated in prior art FIG. 5, and more particularly described in prior art FIG. 7, takes electrical signals from sensor chip 54 and derives electrical signals suitable for driving cathode-ray tube 68. Rays of light 64 from cathode-ray tube 68 are focused by secondary optical system 66 in such a manner that they can be viewed by the eye 62 of the user of the camera. The viewfinder systems of prior art FIG. 5 and prior art FIG. 6 are identical in form to those used in video cameras, and still cameras operating on these principles can be viewed as video cameras in which only one frame is stored when the user presses the exposure button. Cameras of the design illustrated in prior art FIG. 5 and prior art FIG. 6 are capable of rudimentary autofocus and autoexposure by using signals from image sensor 54, as is well known from video cameras incorporating these features. However, the quality of focus and exposure control achievable with such methods is severely limited, and falls well below the quality level necessary for high-resolution still photography.

The electronic systems of prior art digital still cameras illustrated if prior art FIGS. 5 and 6 are illustrated in prior art FIG. 7. Output signals from sensor chip 54 are processed by processing electronics 70 and stored on storage medium 72. Sensor chip 54 can be either of the CCD or CMOS type. Storage medium 72 can be magnetic tape, magnetic disk, semiconductor flash memory, or other types known in the art. Control electronics 74 provides signals for controlling and operating sensor chip 54, processing electronics 70, and storage medium 72. In addition, processing electronics 70 provides output signals suitable for driving either flat-panel display 58 or cathode-ray tube 68, and control electronics 74 provides signals for controlling and operating either flat-panel display 58 or cathode-ray tube 68.

All of the elements and arrangements illustrated in prior art FIGS. 1, 2, 3, 4, 5, 6, and 7 are extremely well known in the art, and are embodied in hundreds of commercial products available from camera manufacturers around the world. In some cases, combinations of the techniques illustrated in these figures can be found in a single product.

### SUMMARY

The drawbacks and disadvantages of the prior art are overcome by the all-electric high-resolution digital still camera.

An electronic camera system includes a semiconductor sensor array having a plurality of pixels located on an optical axis at the focal plane of a lens system associated with the camera. Each of the pixels generates an output signal that is a function of light incident thereon. A sensor control circuit is coupled to the semiconductor sensor array and is adapted to produce sensor control signals for controlling the operation of the pixels in the semiconductor sensor array in response to input from the user of the camera system. Circuitry is provided for producing two sets of image output signals from the semiconductor sensor array. The first set of image output signals are indicative of the intensity of the light at a first set of the pixels when the sensor control signals are in a first state, and the second set of image output signals are indicative of the intensity of the light at a second set of the pixels when the sensor control signals are in a second state. The first set of pixels includes a greater number of pixels than the second set of pixels. A storage medium is coupled to the sensor array and is adapted for storing a representation of the first set of image output signals when the sensor control signals are in the first state. A display is adapted for displaying the second set of image output signals when the sensor control signals are in the second state.

In one camera system, the first set of pixels is a majority of the pixels in the array and the second set of pixels is a preset fraction of the pixels in the array that is less than half of the total pixels in the array. The array can be arranged as a plurality of rows and columns of pixels and the second set of pixels can comprise at least a majority of pixels in every M rows of the array and at least a majority of pixels in every N rows of the array, where M and N are greater than one. M and N can be equal to one another.

According to other features of the present invention, the semiconductor sensor array is a CMOS sensor array, and can be a vertical color filter CMOS sensor array. The storage medium can advantageously be a semiconductor memory array. The camera system disclosed herein may also include a lens system that can be focussed using focus signals and may include apparatus for computing focus signals indicating the quality of focus of the light from the image output signals when the sensor control signals are in the second state and for generating lens control signals in response to the focus signals.

### BRIEF DESCRIPTION OF THE FIGURES

Referring now to the figures, wherein like elements are numbered alike:

FIG. 1 is a cross-sectional diagram of one example of a prior art digital camera;

FIG. 2 is a block diagram of an exemplary electronic control system used in prior art digital cameras as illustrated in FIG. 1;

FIG. 3 is a cross-sectional diagram of another example of a prior art digital camera;

FIG. 4 is a block diagram of an exemplary electronic control system used in prior art digital cameras as illustrated in FIG. 3;

FIG. 5 is a cross-sectional diagram of another example of a prior art digital camera;

FIG. 6 is a cross-sectional diagram of another example of a prior art digital camera similar in design as illustrated in FIG. 5;

FIG. 7 is a block diagram of an exemplary electronic control system used in prior art digital cameras as illustrated in FIGS. 5 and 6;

FIG. 8 is a cross-sectional diagram of a digital still camera according to the present invention;

FIG. 9 is a cross sectional diagram of a semiconductor illustrating a vertical color filter pixel sensor employing epitaxial semiconductor technology;

FIG. 10 is a schematic diagram of an illustrative metallic oxide semiconductor (MOS) active pixel sensor incorporating an auto-exposure sensing circuit;

FIG. 11 is a timing diagram that illustrates the operation of the pixel sensor of FIG. 10;

FIG. 12 is a timing diagram that illustrates the operation of the pixel sensor of FIG. 10;

FIG. 13 is a block diagram of an electronic control system suitable for use in the digital camera of the present invention;

FIG. 14 is a block diagram of an electronic camera employing scanning circuitry;

FIG. 15 is a block diagram illustrating the main components of scanning circuitry for an active pixel sensor array;

FIG. 16 is a flowchart illustrating the method of address counting logic used within the row and column address counters for pixel sensor selection;

FIG. 17 is a schematic diagram of an illustrative 1-bit slice of a representative flexible address generator for use in the scanning circuitry associated with an active pixel sensor array;

FIG. 18 is a simplified schematic diagram of a flexible address generator formed from a plurality of flexible address generator bit slices of FIG. 17;

FIG. 19 is a simplified schematic diagram of an illustrative embodiment of the flexible address generator for use where the size of the array is not equal to an exact power of two;

FIG. 20 illustrates subsampling using contiguous 4×4 pixel blocks for a N×M resolution image;

FIG. 21 is an example of subsampling 1 out of 9 pixels selected from a 3×3 pixel block;

FIG. 22 is another example of subsampling 1 out of 9 pixels selected from a 3×3 pixel block;

FIG. 23 illustrates an example of subsampling 1 out of 16 pixels selected from a 4×4 pixel block;

FIGS. 24-30 illustrate examples of periodic focusing images, produced by subsampling, as seen in a reduced resolution electronic viewfinder;

FIG. 31 is a table illustrating a method for computing the coordinates of non-integer pixel blocks;

FIG. 32 illustrates the partitioning of an image into pixel blocks for non-integer resolution reduction;

FIG. 33 is a flow chart illustrating a method for computing pixel addresses for use in producing subsampled images;

FIG. 34 is a block diagram of an digital camera employing scanning; and

FIG. 35 is a block diagram of the main components of scanning circuitry for an active pixel sensor array.

### DETAILED DESCRIPTION

The present application provides an all-electronic implementation of a viewfinder, autofocus and autoexposure problems, using information generated by primary sensor chip, not requiring additional sensors. This invention, therefore, obviates the need for mechanical complexity and precise alignment of multiple elements.

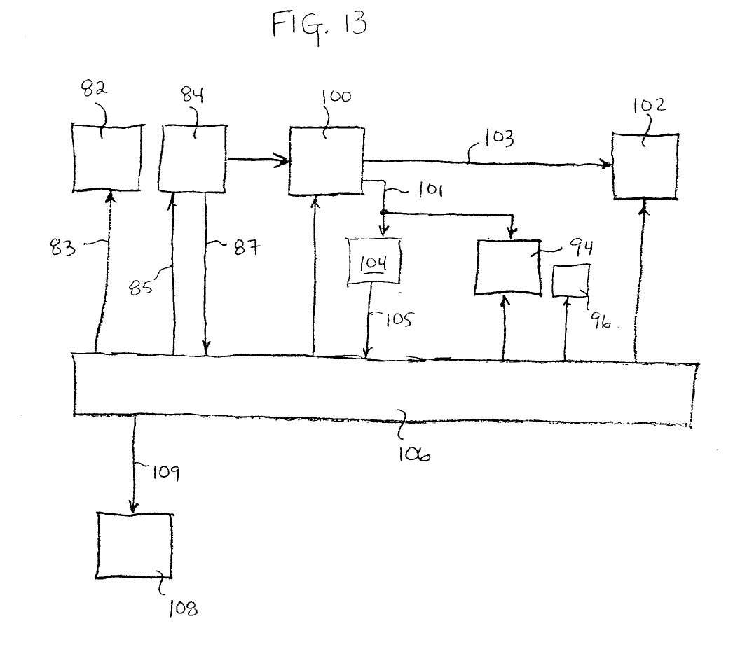

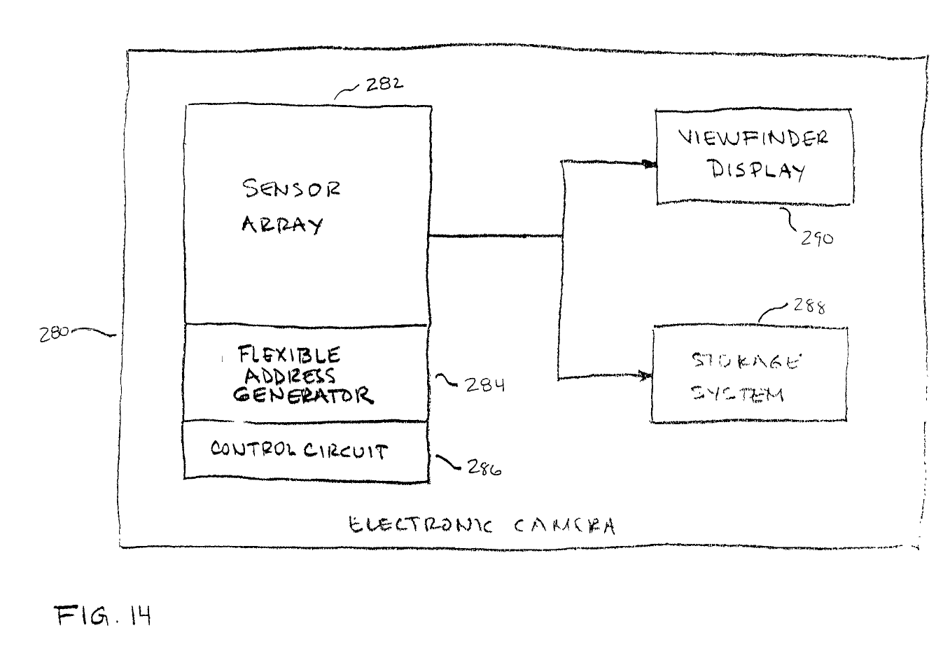

A digital still camera is illustrated in FIG. 8. Rays of light 80 from a scene to the left of the figure are focused by primary optical system 82 onto a sensor chip 84.A preferred phototransducer for use in the sensor chip 84 is a triple-well photodiode arrangement, which is described more fully below and is illustrated in FIG. 9. Sensor circuits suitable for use can be a high-sensitivity storage pixel sensor having auto-exposure detection, which is described more fully below and illustrated in FIGS. 10-12. Optical system 82 and sensor chip 84 are housed within light-tight housing 86 to prevent stray light from falling on sensor chip 84 and thereby corrupting the image formed by rays 80. An electronic system, not illustrated in FIG. 8, and more particularly described in FIG. 13, takes electrical signals from sensor chip 84 and derives electrical signals suitable for driving display chip 94, which can be either of the micro-machined reflective type as supplied by Texas Instruments, or of the liquid-crystal coated type, as supplied by micro-display vendors such as Kopin, MicroDisplay Corp. or Inviso.

Display chip 94 is illuminated by light-emitting-diode (LED) array 96. Reflected light from display chip 94 is focused by secondary optical system 90 in such a manner that they can be viewed by the eye 92 of the user of the camera. Alternatively, display chip 94 can be an organic light-emitting array, in which it produces light directly and does not require LED array 96. Both technologies give bright displays with excellent color saturation and consume very little power, thus being suitable for integration into a compact camera housing as illustrated in FIG. 8. A light-tight baffle 88 separates the chamber housing sensor chip 84 from that housing LED array 96, display chip 94, and secondary optical system 90. Viewing the image from display chip 94 in bright sunlight is made easier by providing rubber or elastomer eye cup 98.

The operation of the arrangement of FIG. 8 is best understood by reference to FIG. 13, which illustrates a block diagram of the electronics used to operate and control the camera of FIG. 8. Output signals from sensor chip 84 are processed by processing electronics 100 and stored on storage medium 102. Sensor chip 84 must possess certain unique capabilities that allow it to be used in the present invention. Storage medium 102 can be magnetic tape, magnetic disk, semiconductor flash memory, or other types known in the art. Control electronics 106 provides signals for controlling and operating sensor chip 84, processing electronics 100, and storage medium 102. In addition, processing electronics 100 provides output signals 101 suitable for driving display chip 94, and control electronics 106 provides signals for controlling and driving LED array 96. Processing electronics 100 may, under favorable circumstances, be located on and integrated with sensor chip 84.

For a high-resolution still camera, sensor chip 84 will have a resolution (number of pixels) much larger than that of display chip 94. For that reason, only a fraction of the data used for a captured image is used for a viewfinder image. Accordingly, signals 101 will have fewer pixels per frame, and will have a much higher frame rate than signals 103 that are generated by processing electronics 100 for storage on medium 102.

A great advantage can be achieved by using a design for sensor chip 84 in which a subset of pixels can be addressed. In a preferred embodiment, addressing logic is utilized as described below and illustrated in FIGS. 14-19. For example, every 4th pixel in every 4th row can be addressed in sequence, thereby allowing the scanout time per frame to be shortened by a factor of 16.

For really high-resolution sensor chips, the scanout time can dominate the frame refresh rate of the viewfinder. For example, a 4000×4000 pixel sensor chip has 16,000,000 pixels. When scanned at a 20 MHz rate, the frame rate is 1.25 frames per second, which is much too slow for realistic viewfinding in real time. When every 4th pixel in every 4th row is scanned at 20 MHz, a 1000×1000 display chip can be updated at 25 frames per second, a rate that presents to the user a highly realistic and pleasing real-time viewfinder. CCD sensors can realize a similar frame-rate advantage by “binning” a number of pixels in each clock cycle, as is well known in the art. It is an essential feature that a fast frame rate be used to achieve a real-time, lifelike viewfinder that is transparent to the user. When an exposure is captured, the entire 16,000,000 pixels in the example used above are scanned out through processing electronics 100 into storage medium 102 under control of control electronics 106.

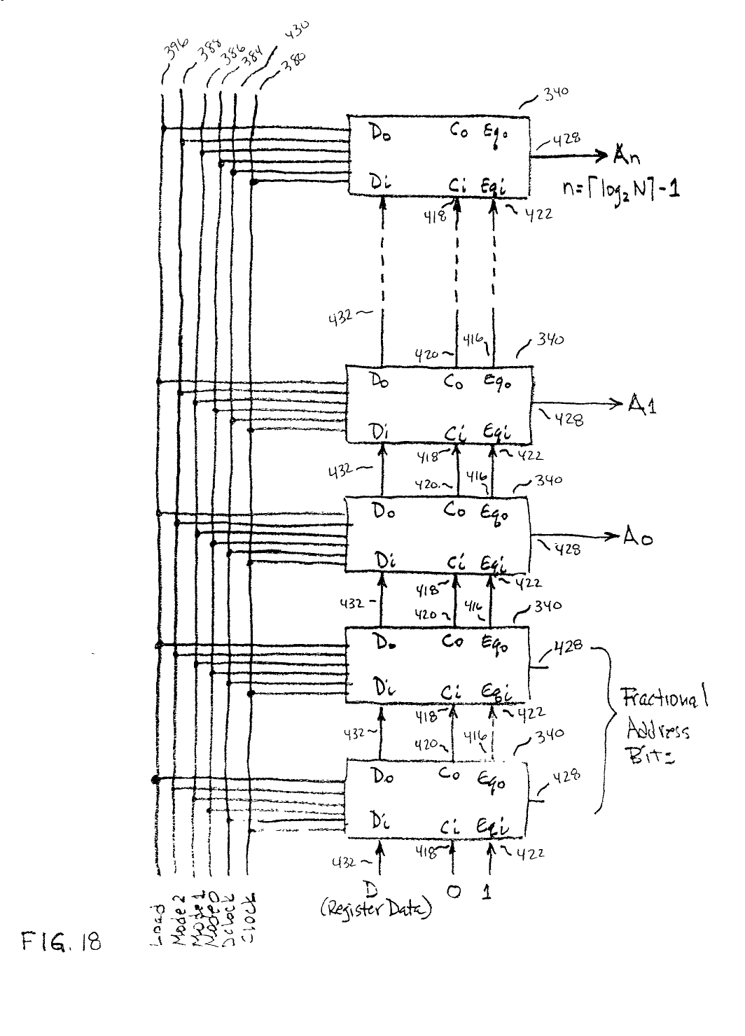

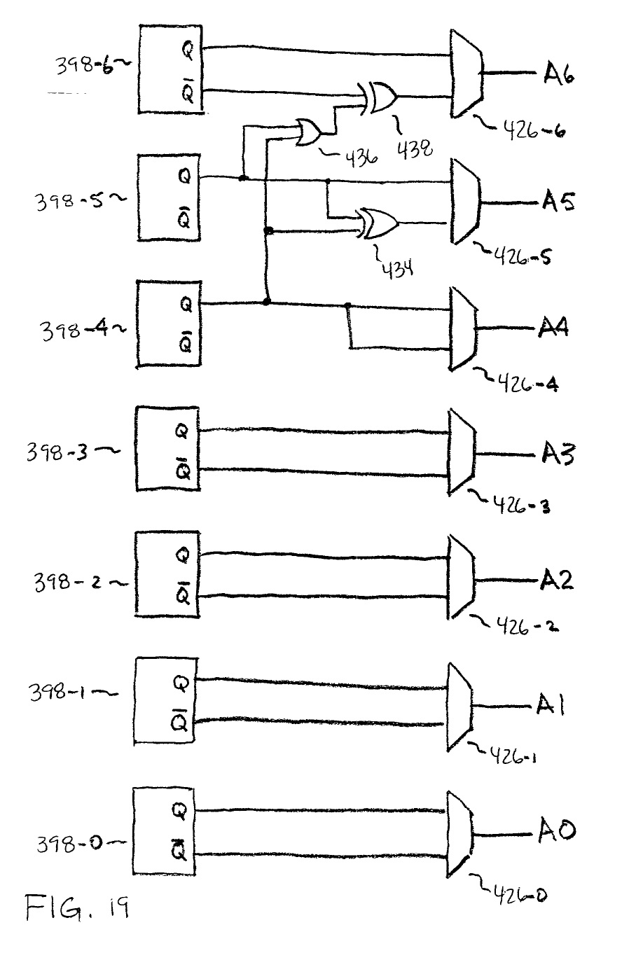

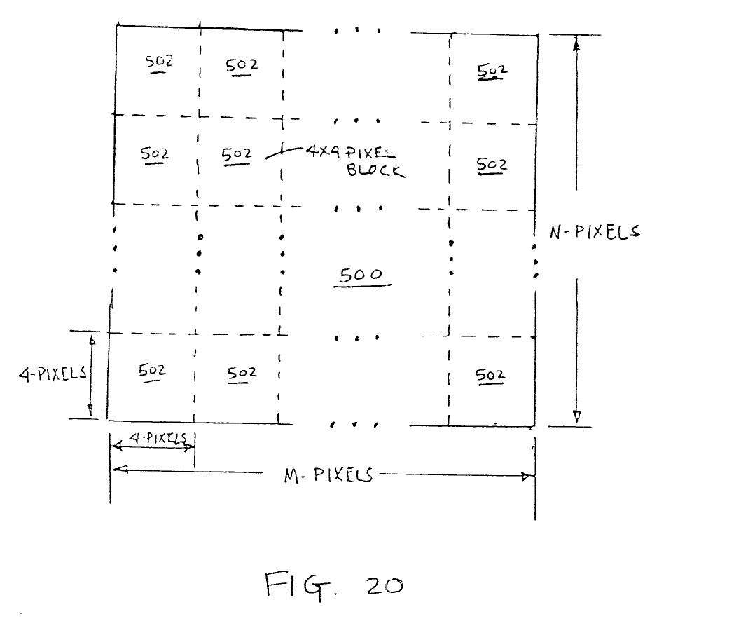

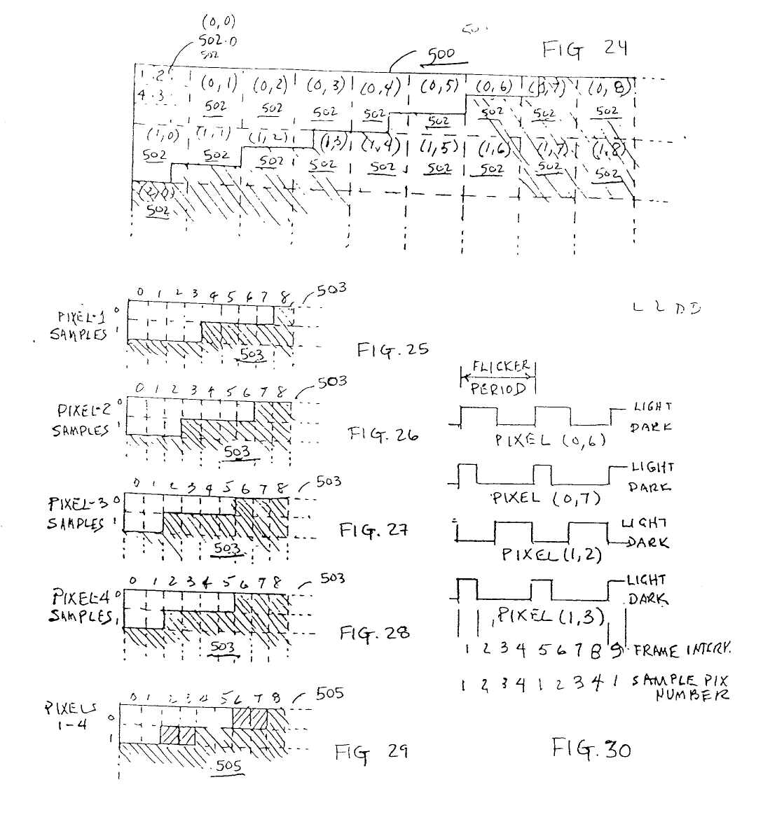

It is important that both autofocus and autoexposure actions occur in real time, without any delay noticeable to the user. It is most desirable that both exposure and focus information be computed from the primary sensor image itself, rather than from signals derived indirectly from other sensors, and subject to misalignment from the primary sensor. The frame-rate advantage described above is, in the preferred embodiment, used to provide an all-electronic autofocus, derived directly from signals generated by the primary sensor chip 84. Focus metric circuit 104 receives viewfinder signals 101 at a high frame rate from processing electronics 100, and computes therefrom signals 105 representing the quality of focus of any given viewfinder frame. A method for computing said focus metric is described more fully below and illustrated in FIGS. 20-35. Control electronics 106 manipulates the focus of primary optical system 82 through electrical signals 83 thereby, after a few frames, bringing the image into focus on sensor chip 84. Primary optical system 82 is, in the preferred embodiment, an interchangeable ultrasonic lens of the EOS family, well known in the art.

Exposure information must be computed even more quickly than focus information if it is desired to accomplish true through-the-lens (TTL) metering during the exposure. In this mode of operation, the integration of light onto sensor chip 84 is allowed to proceed until a desired exposure condition is achieved. At that time, the integration period is terminated and the image stored on medium 102. In the preferred embodiment, the achievement of the desired exposure condition is computed at the image plane itself, within sensor chip 84, and is described more fully below and illustrated in FIGS. 10-12. Signals 87 convey the exposure condition from sensor chip 84 to control electronics 106. Control electronics 106, upon receiving information on signals 87 indicating the achievement of the desired exposure condition terminates the integration time on sensor chip 84 through signals 85, and, if the exposure is taken with a TTL flash unit 108, the flash is terminated by control electronics 106 through signals 109, as is well known in the art.

As previously discussed, a non-limiting and illustrative example of a phototransducer suitable for use as the sensor chip 84 is a vertical color filter multiple photodiode arrangement. The following provides a more detailed description of the vertical color filter multiple photodiode arrangement.

As illustrated in FIG. 9, the six-layer structure of alternating p-type and n-type regions can be formed using a semiconductor substrate 200 of a first conductivity type as the bottom layer in which a blanket diffusion-barrier implant 202 of the first conductivity type and a single well 204 of a second opposite conductivity type are disposed. The diffusion barrier 202 prevents carriers generated in the substrate from migrating upward to the green photodiode and the well 204 acts as the detector for the red photodiode. In this embodiment, a first epitaxial layer 206 having the first conductivity having a blanket diffusion-barrier implant 208 of the first conductivity type is disposed over the surface of the semiconductor substrate 200 and the substrate well 204 and a well 210 of the second conductivity type is disposed in the first epitaxial layer 206. The diffusion barrier implant 208 prevents carriers generated in the first epitaxial layer 206 from migrating upward to the blue photodiode and the well 208 acts as the detector for the green photodiode. A second epitaxial layer 212 of the first conductivity type is disposed over the surface of the first epitaxial layer 206 and its well 210 and a doped region 214 of the second conductivity type (which may be a lightly-doped-drain implant) is formed in the second epitaxial layer 212. Doped region 214 forms the blue detector.

Contact is made to the buried green detector 210 and the buried red detector 204 via deep contacts. The contact for the buried green detector 210 is formed through second epitaxial layer 212 and the contact for buried red detector 204 is formed through second epitaxial layer 212 and through first epitaxial layer 206.

The hatched areas of FIG. 9 illustrate the approximate locations of the implants used to create the p-type and n-type regions of the structure. The dashed line 216 defines the approximate border between the net-P and net-N doping for the blue detector 214. Similarly, the dashed line 218 defines the approximate border between the net-P and net-N doping for the green detector 210 with its vertical portion to the surface of the second epitaxial layer 206 forming the contact to the green detector 210. The dashed line 220 defines the approximate border between the net-P and net-N doping for the red detector 204 with its vertical portion to the surface of the second epitaxial layer 206 forming the contact to the red detector 204.

Other embodiments of the six-layer structure disclosed herein are contemplated and may be realized by using various combinations of layers selected from among the substrate, one or more wells disposed in the substrate, one or more epitaxial layers, and one or more wells disposed in one or more epitaxial layers.

Also as indicated above, a phototransducer suitable for use as the sensor chip 84 is a vertical color filter multiple photodiode arrangement. The following describes the phototransducer and the method of using the phototransducer.

A schematic diagram of an illustrative high-sensitivity pixel sensor 230 incorporating an auto-exposure control is presented in FIG. 10. Photodiode 232 has its anode coupled to a source of fixed potential (illustrated as ground) and a cathode. The cathode of photodiode 232 is coupled to the source of MOS N-Channel barrier transistor 234. The gate of MOS N-Channel barrier transistor 234 is coupled to a BARRIER line upon which a BARRIER control potential may be placed. Persons of ordinary skill in the art will appreciate that the use of MOS N-Channel barrier transistor 234 is optional in storage pixel sensor 230, at the cost of some sensitivity. Independent of the other transistors in the circuit, a barrier transistor 234 can be added to increase the sensitivity (the charge-to-voltage conversion gain) in darker areas of the image. The MOS N-Channel barrier transistor 234 allows essentially all of the charge from the photodiode to charge the gate capacitance of the first source follower transistor 240, providing a high gain, until that gate voltage falls low enough to turn the barrier transistor 234 on more, after which the storage pixel sensor 230 operates in the lower-gain mode (for lighter areas) in which the charge is charging both the photodiode capacitance and the gate capacitance.

The cathode of photodiode 232 is coupled to a photocharge integration node 236 (represented in FIG. 10 as a dashed line capacitor) through the MOS N-Channel barrier transistor 234. A MOS N-Channel reset transistor 238 has its source coupled to the photocharge integration node 236, its gate coupled to a RESET line upon which a RESET signal may be asserted, and its drain coupled to a reset potential VR.

The photocharge integration node 236 comprises the inherent gate capacitance of first MOS N-Channel source-follower transistor 240, having a drain connected to a voltage potential VSFD1. The voltage potential VSFD1 may be held fixed at a supply voltage V+ (which may be, for example, about 3-5 volts depending on the technology) or may be pulsed as will be disclosed further herein. The source of MOS N-Channel source-follower transistor 240 forms the output node 242 of the source-follower transistor and is coupled to the drain of MOS N-Channel bias transistor 244 operating as a current source. The source of MOS N-Channel bias transistor 244 is coupled to a fixed voltage potential, such as ground. The gate of MOS N-Channel source-follower bias transistor 244 is connected to a bias voltage node. The voltage presented to the bias voltage node sets the bias current flowing through MOS N-Channel source-follower bias transistor 244. This voltage may be fixed, or may be pulsed to conserve power. The use of MOS N-Channel source-follower bias transistor 244 is optional. This device can be used in combination with a saturation level transistor to implement an auto-exposure detection function.

The output node 242 of the source-follower transistor is coupled to a capacitive storage node 246 (represented in FIG. 10 as a dashed line capacitor). The output node 242 of the source-follower transistor can be coupled to the capacitive storage node 246 through a MOS N-Channel transfer transistor 248. The gate of MOS N-Channel transfer transistor 248 is coupled to a XFR line upon which a XFR signal may be asserted. MOS N-Channel transfer transistor 248 is an optional element in the storage pixel sensor.

The capacitive storage node 246 comprises the inherent gate capacitance of second MOS N-Channel source-follower transistor 250, having a drain connected to a source-follower-drain (SFD) potential and a source. The source of second MOS N-Channel source-follower transistor 250 is coupled to COLUMN OUTPUT line 252 through MOS N-Channel row select transistor 254. The gate of MOS N-Channel row select transistor 254 is coupled to a ROW SELECT line 256.

Second MOS N-Channel source-follower transistor 250 is preferably a large device, having its gate sized at 10 to 100 times the area of first MOS N-Channel source-follower transistor 240. The other transistors in the circuit, first MOS N-Channel source-follower transistor 240, are preferably sized to near minimum length and width.

A great advantage can be achieved by using a design for sensor chip 84 in which a subset of pixels can be addressed. For example, every 4th pixel in every 4th row can be addressed in sequence, thereby allowing the scanout time per viewfinder image frame to be shortened by a factor of 16.

Referring now to FIG. 11, a timing diagram illustrates the method of using pixel sensor 10 (illustrated in FIG. 10). Initially, the RESET signal is asserted high. The VR node at the drain of the MOS N-Channel reset transistor 238 is brought from zero volts to the voltage VR. This action resets all pixel sensors in the array by placing the voltage potential VR (less a threshold of the MOS N-Channel barrier transistor 234) at the cathode of each photodiode 232. According to a preferred method for operating the high-sensitivity pixel sensor as illustrated in FIG. 11, the voltage VR is initially at a low level (e.g., to zero volts) while RESET is high to reset the cathode voltages of all photodiodes in the array to a low value to quickly equalize their states to prevent image lag. Then the voltage VR is raised (e.g., to about 2 volts) for a predetermined time (preferably on the order of a few milliseconds) while the RESET signal is still asserted to allow the photodiodes in all pixel sensors to charge up to about 1.4 volts through their associated MOS N-Channel barrier transistors 234, whose gates are held at about 2 volts. The black level at the integration node is thus set to VR, less a little for the capacitive turn-off transient from the MOS N-Channel reset transistor, and the photodiodes are reset to their respective appropriate levels as determined by their respective barrier transistor thresholds. An advantage of this method is that those thresholds do not affect the black level that is read out. After reset ends and integration starts, some charge will still leak across the barrier by subthreshold conduction, but it should be about the same for all pixels, or at least be a monotonic function of light level.

According to a particularly advantageous operation of the storage pixels sensor, the barrier transistor 234 and the reset transistor 238 are identically sized so as to exhibit identical voltage thresholds (Vth). The active level of the RESET signal is chosen such that VRESET<VR+Vth, to achieve better tracking of nonlinearities.

When the RESET signal is de-asserted and photointegration begins, charge accumulates on the photocharge integration node 236. Because MOS N-Channel barrier transistor 234 is barely conducting, photoinduced charge trickles across its channel and charges photocharge integration node 236 (by lowering its voltage) without lowering the voltage on the cathode of the photodiode 232. This is advantageous because it minimizes the capacitance charged by the photocurrent, thereby maximizing the sensitivity (volts per photon).

Persons of ordinary skill in the art will appreciate that the MOS N-Channel reset transistor 238 can be coupled directly to the cathode of the photodiode 232, but such an arrangement requires that the voltage VR be set precisely relative to the barrier voltage and threshold. This is not preferred since the thresholds can vary.

The voltage at the source of first MOS N-Channel source-follower transistor 240, and hence its output node 242, follows the voltage on its gate (the photocharge integration node 236). In embodiments that employ MOS N-Channel transfer transistor 248, the XFR signal is asserted throughout the reset period and the integration period and is de-asserted to end the integration period, as illustrated in FIG. 11. The low level of the XFR signal is preferably set to zero or a slightly negative voltage, such as about −0.2 volts, to thoroughly turn off transfer transistor 248.

To read out a pixel sensor, the SFD node at the drain of the second MOS N-Channel source-follower transistor (labeled VSD2 in FIG. 11) is driven to the voltage VSFD, the ROW SELECT signal for the row of the array containing the pixel sensor 230 is asserted, and the output signal is thereby driven onto COLUMN OUTPUT line 252. The timing of the assertion of the VSFD2 signal is not critical, except that it should remain high until after the ROW SELECT signal is de-asserted as illustrated in FIG. 11. It may be advantageous to limit the voltage slope at the rising edge of the ROW SELECT signal if VSFD2 is raised first.

Referring now to FIG. 12, if the XFR transistor is not present, the storage node may be isolated by lowering SFBIAS (preferably to zero or a slightly negative voltage such as about −0.2 volts) and setting VR low, and then asserting the RESET signal. This sequence turns off the first source follower 240 by lowering the voltage on its gate while its load current is turned off, thereby storing its output voltage.

In FIG. 12, the VR falling edge and the RESET rising edge are illustrated following closely on the terminate signal, since these transistors isolate the storage node to end the exposure. In FIG. 10, the corresponding transitions are illustrated with more delay since they are not critical when XFR falling isolates the storage node. The SFBIAS signal needs to fall only in the case of FIG. 12, when there is a transfer transistor the bias can be steady.

Also illustrated in FIG. 12 is the signal VSFD1 to illustrate an in which VSFD1 is pulsed. As disclosed herein, the VSFD1 node may always be left high, or, as illustrated in FIG. 12. VSFD1 may be pulsed thus saving power. In embodiments in which VSFD1 is pulsed, terminate will become true during a pulse. VSFD1 is held high until RESET goes high or, in embodiments employing a transfer transistor, until XFR goes low.

Second MOS N-Channel source-follower transistor 250 is larger than first MOS N-Channel source-follower transistor 240, and its gate capacitance (the capacitive storage node 246) is, therefore, correspondingly larger. This provides the advantage of additional noise immunity for the pixel sensor 230 because more charge needs to be transferred to or from the capacitive storage node 246 to cause a given voltage change than is the case with the photocharge integration node 236.

The control signals depicted in FIGS. 11 and 12 may be generated using conventional timing and control logic. To this end, timing and control logic circuit 258 is illustrated in FIG. 10. The configuration of timing and control logic circuit 258 will depend on the particular embodiment, but in any event will be conventional circuitry, the particular design of which is a trivial task for persons of ordinary skill in the art having examined FIGS. 11 and 12 once a particular embodiment is selected.

Referring again to FIG. 10, an auto-exposure circuit 260 for use with pixel sensors according to another embodiment is disclosed. Each pixel in the array includes a MOS N-Channel saturation level transistor 262, having its source coupled to the output node 242 of the first MOS N-Channel source-follower transistor 240, its gate coupled to SAT. LEVEL line 264 and its drain connected to a global current summing node 266. Global current summing node 266 is coupled to a current comparator 268. Persons of ordinary skill in the art will appreciate that current comparator 268 may comprise a diode load or a resistor coupled between a voltage source and global current summing node 266 driving one input of a voltage comparator. The other input of the voltage comparator would be coupled to a voltage representing a desired number of saturated pixels. Alternatively, an analog-to-digital converter may be used and the comparison may be done digitally.

A saturation level transistor 262 can be used, only if the bias transistor 244 is present, to divert the bias current from saturated pixel sensors onto a global current summing line that can be monitored during exposure to determine how many pixels have reached the saturation level. External circuits can control the threshold for what is deemed saturation, and can measure the current instead of just comparing it to a threshold, so it is possible through this added transistor and global current summing line to measure how many pixel sensors have crossed any particular level. Therefore, by performing rapid variation of the threshold (SAT. LEVEL) and rapid measurement (e.g., through an A/D converter and input to a processor), it is possible to have access to a complete cumulative histogram of exposure levels during the exposure; from this information, it is possible to make more complex determinations of good exposure levels, beyond the simple threshold method used in a preferred embodiment.

When the bias transistor 244 is present, isolating the storage node involves timing signals to turn off both the bias transistor 244 and the first source follower 240. It is simpler, and potentially advantageous in terms of storage integrity, to include a transfer transistor 248 that can isolate the storage node under control of a single logic signal. The transfer transistor 248 can also be added to the basic circuit, even without the bias transistor, for a similar advantage, since even turning off the first source follower transistor 240 reliably involves coordinating the Reset and VR signals, which is a complexity that can be eliminated with the transfer transistor 248.

In operation, the SAT. LEVEL line 44 is driven to a voltage VSAT corresponding to a selected photocharge saturation level. Because accumulation of photocharge drives the output node 242 of the first MOS N-Channel source-follower transistor 240 downward, MOS N-Channel saturation level transistor 262 is initially turned off because its gate voltage at VSAT is lower than the voltage at node 236. MOS N-Channel saturation level transistor 262 remains off until accumulation of photocharge at photocharge integration node 236 has lowered its voltage below VSAT (and that at the source of MOS N-Channel saturation level transistor 262, common to the output node 242 of the first MOS N-Channel source-follower transistor 240, to a level one Vt below the voltage VSAT). At this point, MOS N-Channel saturation level transistor 262 turns on and starts to draw current (less than or equal to the bias current through bias transistor 244) from the global current summing node 266.

As will be appreciated by persons of ordinary skill in the art, other pixel sensors in the array will also begin to accumulate enough photocharge to turn on their MOS N-Channel saturation level transistors 262, thus drawing additional current from node 266, and further dropping the voltage on global current summing node 266. As will be appreciated by persons of ordinary skill in the art, comparator 268 may be a voltage comparator having one input coupled to global current summing node 266 and one input coupled to a voltage VTERM chosen to correspond to the voltage on global current summing node 266 when a selected number of pixels are saturating (i.e., have their MOS N-Channel saturation level transistors 262 turned on). When the voltage on global current summing node 266 equals VTERM, the comparator 268 generates a TERMINATE EXPOSURE signal that can be used to terminate the exposure period in one of numerous ways, such as by closing a mechanical shutter or initiating end-of-exposure signals (such as the XFR signal) to control the pixel sensors. The TERMINATE EXPOSURE signal can also be used to quench a strobe flash if desired.

Alternatively, A/D converter 270 may be coupled to global current summing line 266 to convert the voltage representing the global summed current to a digital value that can be processed by employing a smart auto-exposure algorithm illustrated at reference numeral 272.

The auto-exposure circuit 260 may be advantageously operated in a power saving mode by simultaneously pulsing both the VSFD1 signal to the drain of the source-follower transistor 240 and one or both of the SF bias signal supplied to the gate of source-follower bias transistor 244 and the SAT. LEVEL signal supplied to the gate of saturation level transistor 262. In such a mode, the auto-exposure sensing current flows only when these signals are pulsed, at which time the overexposure sensing is performed. At other times during photointegration, the overexposure currents from each pixel do not flow, thus saving power. When this mode of operation is used, the auto-exposure circuit 260 can be advantageously used at higher current levels for better signal-to-noise ratio.

According to another mode of operating the auto-exposure circuit 260, the SAT. LEVEL voltage at the gates of all saturation level transistors 262 in an array can be swept from zero to the maximum level do develop a full cumulative distribution of the states of all pixels in the array. This mode of operation is most useful when A/D converter 270 is used in the auto-exposure circuit 260. In embodiments employing optional transfer transistor 248, this device should either be turned off before the ramping of SAT. LEVEL voltage each measurement cycle, or an extra cycle should be performed with the SAT. LEVEL voltage low in order to store a signal voltage that is not clipped to the variable SAT. LEVEL voltage. An example of an autoexposure algorithm that could use this cumulative distribution information is one that would analyze the distribution and classify the scenes as being backlit or not, and set different values of SAT. LEVEL and i-threshold accordingly, during exposure.

As discussed earlier, a great advantage can be achieved by using a design for sensor chip 84 in which a subset of pixels can be addressed. The following provides a more detailed description of addressing logic for integration into sensor chip 84.

Referring to FIG. 14, a block diagram of an electronic camera 280 employing scanning circuitry is illustrated. Electronic camera 280 includes a pixel sensor array 282, such as an active pixel sensor array. Pixel sensor array 282 is controlled by a flexible address generator circuit 284. Flexible address generator circuit 284 is controlled by a control circuit 286 that provides all of the signals necessary to control reading pixel data out of the array 282. The flexible address generator circuit 284 and control circuit 286 may be used to read full high-resolution image data out of the pixel sensor array 282 and store that data in storage system 288. The pixel sensor array 282 is a high-resolution active pixel sensor array suitable for use in digital still or video cameras. Such active pixel sensor arrays are generally displayed onto a viewscreen so that the user can view and adjust the image. The flexible address generator circuit 284 and control circuit 286 may also be integrated on the same silicon as sensor array 282 and may be used to provide pixel data to a viewfinder display having a resolution lower than that of the full image produced from the pixel sensor array 282.

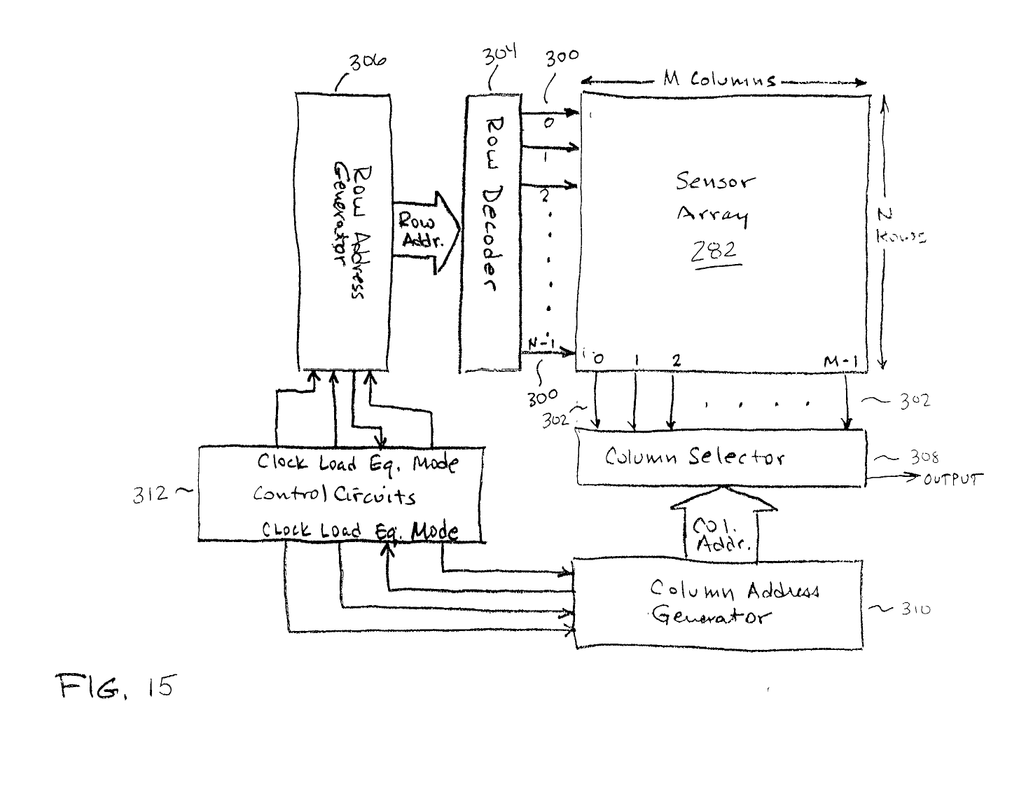

Referring now to FIG. 15, a block diagram illustrates illustrative scanning circuitry comprising the flexible address generator circuitry 284 and control circuitry 286 of FIG. 14 in more detail. The main components of a preferred embodiment of the scanning circuitry are illustrated in FIG. 15. The active pixel sensor array 282 has N rows and M columns of pixel sensors. The active pixel sensor array 282 is connected to the rest of the scanning circuitry components through the row select lines 300, and the column output lines 302. There is a single row select line for each row of pixel sensors in the active pixel sensor array 282, and also a single column output line for each column of pixel sensors in the active pixel sensor array 282. Thus, for the active pixel sensor array 282 illustrated there are N row-address lines 300 and M column output lines 302.

The row-address line signals are generated by row-address decoder 304 driven from row address generator 306. The column line output selection is performed by column selector 308 driven from column address generator 310. Column selector 308 may comprise a decoder or other multiplexing means as is known in the art. The row address generator 306 and column address generator 310 may be thought of as generalized counters and are controlled by control circuitry 312.

In FIG. 15, control circuits 286 are not detailed and may be easily implemented to control the row and column address generators 306 and 310 by persons of ordinary skill in the art from the functions specified herein that will allow the active pixel sensor array to be repeatedly initialized and read out, depending on the initialization and control needs of the chosen imager array.

Row address generator 306 and column address generator 310 are loadable counters operating under the control of control circuits 312. Each counter is loaded with a starting address and is then clocked to count by an increment K until a stop address is reached at which time it provides an “Equal to stop” output signal to the control circuit. The counter is then reset to the start address and the sequence begins again. The counters in row and column address generators 306 and 310 include registers for storing the values of the start address, the stop address, and the value of K, in sets for one or more modes. The control circuitry 312 and row and column address generators 306 and 310 are arranged to clock through each selected column in a row, and then increment the row address generator by K to clock each selected column in the next selected row.

The “Equal to stop” signal out of the row address generator signals the final row and the control circuits 312 subsequently cause an initialization of the sensor array, so that a new image will be captured after each full cycle of rows is completed.

Persons of ordinary skill in the art of sensor arrays will realize that other timing signals and delays may be needed between rows or between images, and that delay elements and other logic and timing elements can be employed to realize such delays and additional timing signals, and to synchronize the image exposure and readout to the other parts of the camera system. Control circuits 312 are not a critical part of the embodiment, and would typically not be fabricated on the same silicon substrate with the sensor array and flexible addressing circuitry. The Mode Data lines illustrated in FIG. 15 indicate typical paths both for storing mode definition data in the registers of the counters and for selecting a mode to be operative at any particular time. The complement control signal for each counter is included in the Mode Data.

As will also be apparent to persons of ordinary skill in the art, the stop detection feature of the flexible address generator is optional and the function that it performs could be implemented in a number of different ways in alternate embodiments. For example, the control logic that sends image data from the imager to a storage system can count rows and columns and stop when a predetermined amount of pixel data has been sent. Also, the unit receiving the pixel data from the array could count the rows and columns and signal the controller to stop when a predetermined amount of pixel data has been received. Whichever of these schemes is employed, it provides the advantage that no count or address information is required to be sent in real time to or from the imager integrated circuit.

A complement control signal is used if it is desired to mirror the image from the active pixel sensor array 282 in either the X or the Y direction. An image is normally split into three different color beams by a color separation prism, and each separate color beam is sent to a different active pixel sensor array. Such prisms may produce one color separation beam that is mirrored with respect to the other two color separation beams. Re-mirroring by readout reversal may then be necessary to return a particular color beam image to the same orientation as the other color beam images before the three color separation beams are recombined to form the final image. The complement control signal will reverse the pixel sensor addressing scheme of the row or column-address counter by subtracting the count from the highest row or column address. In the typical case of an imager having a size equal to a power of two, this subtraction is known as a “one's complement”, which is an inversion of each bit, causing the particular active pixel sensor array to be read out in a mirrored fashion and returning the resulting image to the desired orientation.

After receiving a Load signal from the control circuits 312, the row address generator 306 loads from its mode data the address of the first row of pixel sensors to be selected from the active pixel sensor array 282. Each time the row address generator 306 is clocked, it provides the address of the next row to be selected to the row decoder 304. The row-address counter 306 is designed to hold several different row-address calculation modes corresponding to different modes of image resolution output.

The row address generator 306 implements a count-by-KN scheme to selectively skip certain rows of pixel sensors of the active pixel sensor array 282. For example, in detail mode where no pixel sensors are skipped, KN=1 and the row address generator 306 will not direct the row decoder 300 to skip any rows. In both the medium and full zoom modes, KN>1 and the row address generator 306 will increment its calculation of the address of the next row to be selected by KN. The row address generator 306 will provide each calculated row address to the row decoder 304. In medium zoom and full frame viewscreen display modes, certain rows on the active pixel sensor array 282 will be skipped over during array readout.

The address of each row to be selected is provided by the row address generator 306 to the row decoder 304, which selects the proper row select line 300 based upon the address provided as is known in the art. Selecting a row line refers to placing a signal on the row line to activate the select nodes of the pixel sensors associated with the selected row line.

The column address generator 310 functions in the same manner as the row address generator 306. Once a Load signal is received from the control circuits 286, the column address generator 310 loads from its mode data the first column address to be read from the active pixel sensor array 282. The column address generator 310 implements a count-by-KM scheme to calculate the address of the subsequent columns to be selected. The column-address counter 310 then provides the column address to the column selector 308. The addressing scheme of the column address generator 310 causes the column selector 308 to selectively skip certain columns of pixel sensors on the active pixel sensor array 282. The column address generator 310 is designed to hold several sets of start, KM, and stop data, allowing for different modes of image resolution and position output.

Several different embodiments of the column selector 308 are possible. The column selector 308 may comprise a column decoder coupled to the column output lines and a pixel value output line via a switch. The switch allows the column decoder to turn on the proper column output line, and sends the desired pixel sensor output value from that column to the pixel value output line. Alternatively, the column selector 38 may comprise a binary tree column selector coupled to the column-output lines.

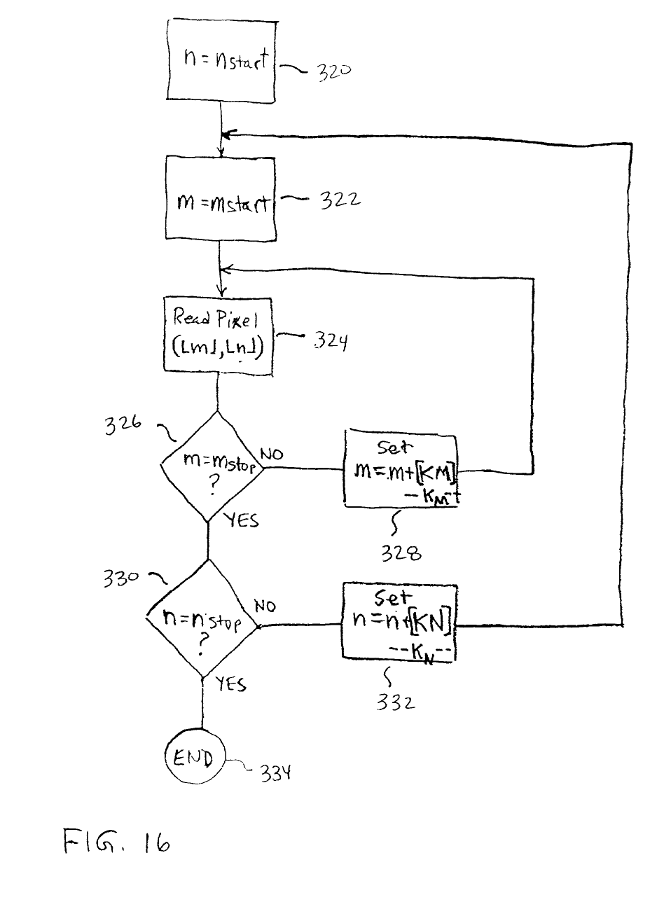

FIG. 16 is a flowchart illustrating the preferred method of implementing the pixel sensor selection scheme for the various pixel sensor selection modes performed by the scanning circuitry. In this flowchart, the current row address number is given as n, and the current column address number is given as m. The logic implements a count-by-KN row skipping scheme and a count-by-KM column skipping scheme. Readout begins at row Nstart and column Mstart, and stops at row Nstop and column Mstop.

First, at step 320, the scanning circuit initializes the first row address number to be selected n=Nstart. At step 322, the scanning circuit initializes the first column-address number to be selected m=Mstart. At step 324, the scanning circuit reads out pixel sensor (n, m). The scanning circuit will then check to see if it has reached the last desired column in the row it is currently reading. At step 326, the scanning circuit determines whether m=Mstop? If no, the scanning circuit increments the column-address number count at step 328, setting m=m+KM. The scanning circuit then returns to step 324. If yes, the scanning circuit proceeds to step 330.

If m=Mstop was true at step 326, then in step 330 it is determined whether n=Nstop and the row count equals the last desired row. If no, the row count is set to n=n+KN at step 332. The scanning circuit then proceeds back to step 322, where it will reinitialize the column-address back to Mstart and continue selecting pixel sensors from the next row. If yes, all desired pixel sensors have been read and the pixel sensor readout ends at step 334.

Each pixel sensor array readout mode will have different values of Nstart, Mstart, Nstop, Mstop, KN and KM. In high-resolution partial image display mode, the user will select Nstart and Mstart. This mode does not skip any pixel sensors and thus KN and KM will both be equal to 1. Nstop and Mstop will be determined by the size of the viewscreen in relation to the size of the active pixel sensor array. The scanning circuit will read pixel sensors from the active pixel sensor array sequentially from the arbitrarily selected starting location until no more pixel sensors can be displayed onto the available viewscreen space.

In full frame viewscreen display mode, the entire image is displayed on the viewscreen and thus Nstart and Mstart may both be equal to zero. For an N row by M column active pixel sensor array, Nstop and Mstop will be set to the greatest multiple of KN and KM less than N and M, respectively, so that counting by KN and KM from zero will exactly reach the stop values. Alternately, rather than a simple equality detector, a digital magnitude comparator may be used so that the stop values N-KN and M-KM can be used. KN and KM will be determined based upon the ratio of the active pixel sensor array size to the viewscreen size.

For the medium zoom modes, Nstart and Mstart are arbitrarily selected by the user. KN and KM will be previously-stored values chosen to produce a viewscreen image resolution in between high-resolution partial image display mode and low-resolution full frame viewscreen mode. Nstop and Mstop will be determined by the size of the viewscreen and the KN and KM values. The scanning circuitry will read pixel sensors from the active pixel sensor array sequentially, counting rows by KN and columns by KM. Active pixel sensor array readout will begin from the arbitrarily selected start location and proceed until no more pixels can be displayed onto the viewscreen.

The pixel sensor addressing method illustrated in FIG. 16 is designed for an active pixel sensor array comprised of rows and columns of pixel sensors arranged in an x-y matrix. While this x-y coordinate system matrix is currently the preferred embodiment of the active pixel sensor array, the pixel sensor selection method illustrated can also be applied to matrixes using different coordinate systems.

The components for an illustrative embodiment of both row address generator 306 and column address generator 310 are illustrated in FIG. 17. FIG. 17 is a schematic diagram illustrating a one bit slice of a flexible address counter 340. The total number of bits used in the flexible address counter 340 will depend upon the size of the active pixel sensor array. A larger pixel sensor array size will require a higher maximum row and column-address count and thus additional flexible address counter bits.

The flexible address generator 340 has three groups of registers for storing three groups of address selection parameters: mode0 produced by the group of registers 342, mode1 produced by the group of registers 344, and mode2 produced by the group of registers 346. Each group of registers contains three register bits and three CMOS transmission gates. Group 342 corresponding to mode0 contains register bits 348, 350, and 352 and CMOS transmission gates 354, 356, and 358. Group 344 corresponding to mode1 contains register bits 360, 362, and 364 and CMOS transmission gates 366, 368, and 370. Group 346 corresponding to mode2 contains register bits 372, 374, and 376 and CMOS transmission gates 378, 380, and 382. Selection between the mode0, mode1, and mode2 data stored in the registers is made using the mode0, mode1, and mode2 control lines 384, 386, and 388, respectively.

Persons of ordinary skill in the art will appreciate that the three different groups of registers illustrated in FIG. 17 are purely illustrative. The flexible address generator 340 can have any number of register groups corresponding to different pixel sensor selection modes of the scanning circuitry.

Each group of registers corresponding to a pixel sensor address selection mode holds Start, K, and Stop values for a different counting sequence. These values provide the inputs for the counter to set the start address value of the addressing counting scheme (Start), to set the increment value (K) by which to increment the pixel sensor address count, and to compare for an end indication (Stop). In each different mode a different pixel sensor address counting scheme will be produced. The registers for each counting sequence mode are loadable by conventional means as is known in the art, and thus their values can be changed depending upon the start location and viewing mode chosen by the user.

Start values are held in register bits 352, 364, and 376. Depending on whether mode 0, 1 or 2 is selected, one of these three register bits will place a Start value on line 390.K values are held in register bits 350, 362, and 374. Depending on whether mode 0, 1 or 2 is selected, one of these three register bits will place a K value on line 392. Stop values are held in register bits 348, 360, and 372. Depending on whether mode 0, 1 or 2 is selected, one of these three register bits will place a Stop value on line 394.

The control circuit 286 illustrated in FIG. 14 provides Load, Clock, and Complement signals to the flexible address generator 340 illustrated in FIG. 17. The Load signal 396 causes the counter state flip-flop 398 to be set to the Start value provided from the selected mode on line 390. The Clock signal 400 provides the synchronization for the state changes of the flexible address generator.

The Clock signal 400 allows the adder 402 sum output, the current count plus K, to be stored as the next counter state in flip-flop 398. As the counter state flip-flop 398 increments due to the advancing clock, it provides the current value in flip-flop 398 to the stop check 404, which comprises one inverter 406, three NAND gates 408, 410 and 412, and AND gate 414. The stop check 404 compares the current value stored in flip-flop 398 to the Stop value on line 394. When the current value stored in flip-flop 398 is equal to the Stop value and the Equal-In line 422 is asserted, the output from the stop check 404 asserts the Equal-Out line 416.

The flexible address generator 340 illustrated in FIG. 17 is a ripple counter, or more specifically a ripple-carry accumulator. Ripple counters are well known in the art. This device is commonly called a ripple counter since each more significant stage will receive data carried from the preceding less significant stages in order to produce a valid result. The ripple counter illustrated is the preferred counter embodiment for the scanning circuitry disclosed herein, but other types of digital counters could also be used to perform the counting function of the flexible address generator 340.

Each bit slice of the flexible address generator 340 contains a binary full adder 402. The full adder 402 has three inputs: A, B, and carry-in (Ci) from the previous less significant stage. The full adder 402 also has two outputs: the resulting sum S and a carry-out (Co) to the next more significant stage. The A input is taken from the K value on line 392. The Ci carry input is taken from line 398 and the Co carry output is placed on line 420.

The input ripple equal-to-stop signal (Eqi) from the previous less significant stage of the flexible address counter is carried on line 422. The output of the stop check 404 and the input ripple equal-to-stop signal (Eqi) 422 are input into AND gate 414. AND gate 414 produces the output ripple equal-to-stop signal (Eqo) carried on line 416, which is fed to the next significant stage of the flexible address generator 340. The Eqi 422 and Eqo 416 signals interconnect the various bit slices of the flexible address counter 340 such that the Eqo from the most significant stage will signify that all of the counter bits match the stop value, given that the Eqi of the least significant stage is wired to a logical 1.

The Complement signal 424 triggers the use of the complement of the output signal from flip-flop 398 in multiplexer 426 in order to reverse the counting sequence produced by the flexible address generator 340. The output address bit (Ai) 428 will be combined with the output address bits of all other bit slices of the flexible address generator 340 to determine the row or column address desired. This final row or column address is sent, respectively, to the row decoder or column selector to select the row or column address of the next desired pixel sensor.

To provide additional flexibility, the K value used to increment the counters may be set to a non-integer value. For example, two additional bit slices can be used in the K value, allowing resolution of all starts, K's, stops, and addresses to ¼ pixel units. The two low-order extra bits are included in the counters but discarded on the way to the decoders. A formula for this example that would allow fitting the full frame more closely to a given display size is:

K=(¼)* ceiling (4* max (N/Vr, M/Vc))

meaning load the K register with bits equivalent to the integer:

ceiling (4* max (N/Vr, M/Vc)).

Generalization to other powers of two is apparent to persons of ordinary skill in the art, where “4” in the above formula is replaced by 2^{j} for j fractional bits of precision.

By being included in the counters,, the two extra bits allow for fine-grained control of the zoom function. For example, if K is programmed to be 2.25, and start=1, the counter will yield addresses 1, 3.25, 5.5, 7.75, 10, 12.25, 14.5, 16.75, 19, etc. This counter sequence will be truncated to 1, 3, 5, 7, 10, 12, 14, 16, 19, a sequence which usually jumps by two but jumps by three one quarter of the time, yielding an average jump of 2.25. When using such additional fractional bits, it is also possible to set K values less than 1, in which case zoom-in modes with pixel replication will be possible for imager types that allow reading of rows and columns multiple times.

It will also be apparent to persons of ordinary skill in the art that, in the case where KN or KM are both set to zero, a single row or a single column can be replicated to fill a screen, except that the stop-detect functionality would not work for these modes.

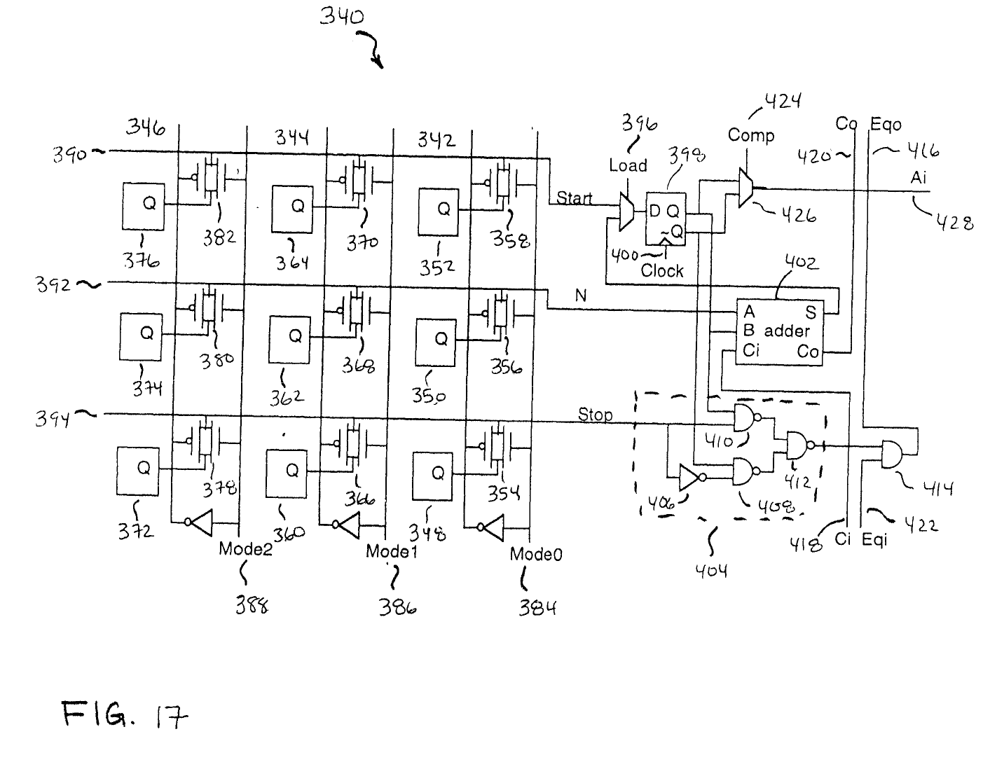

Referring now to FIG. 18, a simplified schematic diagram illustrates an illustrative n-bit flexible address generator formed from a plurality of the flexible address generator bit slices 340 of FIG. 17. The two lower bit slices of the flexible address generator illustrated in FIG. 18 comprise two optional fractional address bits whose address outputs 208 are unused as disclosed herein.

FIG. 18 illustrates all of the interconnections between individual bit slices making up the flexible address generator. The control lines at the left of FIG. 18 are given the same reference numerals as their counterparts in FIG. 17. In addition, the Dclock control line 430 and data input serial data input line 432 are illustrated in FIG. 18. These lines are used to load data into the mode0, mode1, and mode2 registers 342, 344, and 346 in the conventional serial manner well known in the art. Persons of ordinary skill in the art will realize that the data input structure could also be implemented as a parallel data input bus instead of the serial data input line 432 illustrated in FIG. 18.

Arrays having a size such that N or M, or both, is not exactly equal to a power of two, may also be used. FIG. 19 is a simplified schematic diagram of an illustrative embodiment useful where, fDr example, N=80. This size of N lies between 64 and 128 (six and seven address bits, respectively). Therefore, the address generator will require 7 address bits.

In FIG. 19, the flip-flops and multiplexers for all seven bit slices of the flexible address generator are illustrated. The flip-flops are identified with reference numerals 398-0 through 398-6 and the multiplexers are identified with reference numerals 426-0 through 426-6. In each case, the reference numeral suffix indicates the address bit with which the circuit elements in FIG. 19 are associated.

As indicated in FIG. 19, the connections between the flip-flops and the multiplexers for address bits 0 through 3 are as illustrated in the bit slice of FIG. 17. The connections between the flip-flops 398-4, 398-5, and 398-6 and their respective multiplexers 426-4, 426-5, and 426-6 are made as illustrated in FIG. 18 to implement the complementation with respect to the highest address of 79. Specifically, the inputs of multiplexer 426-4 are both connected to the Q output of flip-flop 398-4. The second input of multiplexer 426-5 is driven from XOR gate 434, taking its two inputs from the Q outputs of flip-flops 398-4 and 398-5. The second input of multiplexer 426-6 is driven from OR gate 436 and XOR gate 438. The two inputs to OR gate 436 are taken from the Q outputs of flip-flops 398-4 and 398-5 and the two inputs to XOR gate 438 are taken from the Q output of flip-flop 398-6 and the output of OR gate 436.

The above-described circuit implements the binary function of 127—(A+48) or 79—A, the extra logic adding 48 and then inverting in the lower paths into the complement multiplexers 426-4, 426-5, and 426-6. The circuit of FIG. 19 avoids the need for a different START value in the channel with complementing, although such a circuit is also contemplated.

The following provides a more detailed description of a suitable method for computing a focus metric for use in the present invention.

A simple focusing is to adjust the camera to maximize jaggies that result where crisply focused edges in the original image are aliased into staircase-like jaggies. At a particular depth, in any region of the image, the best focus (i.e. maximum sharpness) will correspond to a maximum jaggieness (i.e. maximum amount of local variance or contrast in the display). However, the effect is subtle, and difficult to maximize by eye.

Subsampling is typically done by taking every n^{th} pixel value from every n^{th} row or, equivalently, by taking a pixel value from one particular location from every contiguous n×n pixel block 502 that makes up the original N×M pixel array 500 as illustrated in FIG. 20. This also results in the subsampled image having the same horizontal and vertical scale reduction. From the example illustrated in FIG. 20, for n×n=4×4, it can be seen that there are n²=16 choices of which pixel to choose as representative of an n×n block of pixels. A choice of a particular identically positioned pixel in each of the n×n blocks results in a unique uniformly subsampled representation of the original image. For each particular pixel position within the 4×4 block, a different, but equally valid, reduced resolution representation of the higher resolution image is obtained.

An improved focusing method that takes advantage of the previously noted fact that subsampling by choosing 1 out of n² pixel positions as the representative pixel position allows n² different and useful uniformly sampled images to be created by subsampling. By sequentially displaying all, or some, of the n² subsampled images, the resulting dynamic display results in a periodic pattern of animated jaggies that displays more of the original pixel data. The periodic pattern corresponds to a closed cycle of displacement over a total displacement that is less that the interval between displayed samples. This dynamic display provides a live viewfinder display that makes focusing over the entire data field easier than focusing on a static single subsampled frame that is repetitively displayed. This results because the human eye is exquisitely sensitive to very small temporal changes in an image, so choosing different sampled pixel alignments has a much greater visual effect on aliased image components than on low spatial frequency components.

A variety of periodic patterns have been investigated for the purpose of determining which subsampling schemes produce the most effective periodic patterns for focusing. Because human vision has maximum sensitivity to flicker in the 3 to 5 Hertz (Hz) frequency region, and because image capture and display rates are in the range of 12 to 30 images per second, decimation factors ranging from 3 to 8 result in flicker intensified images in, or near, the preferred flicker rate range of 3 to 5 Hz.

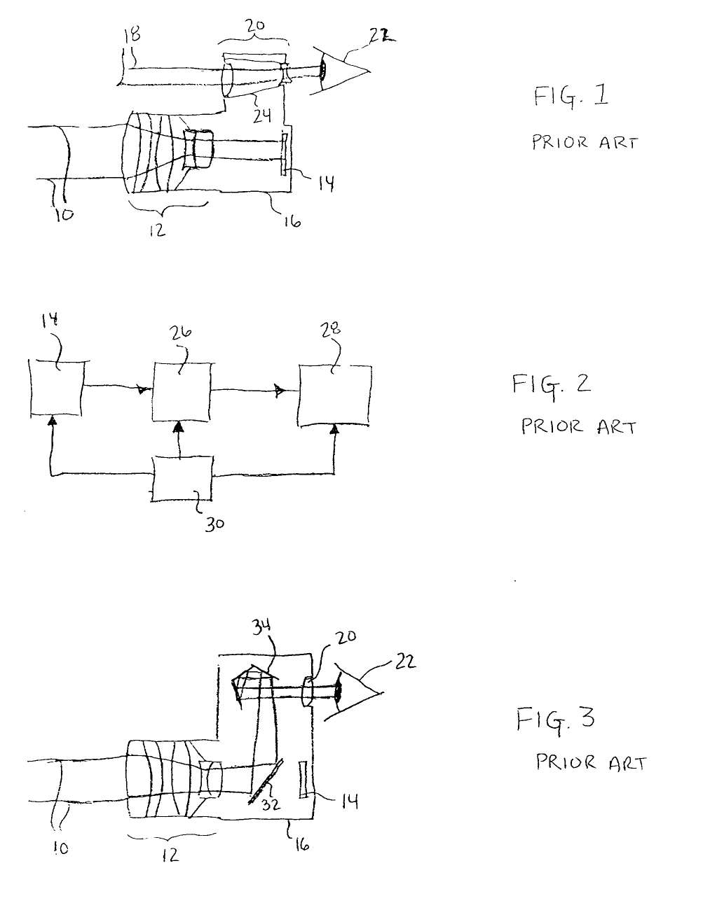

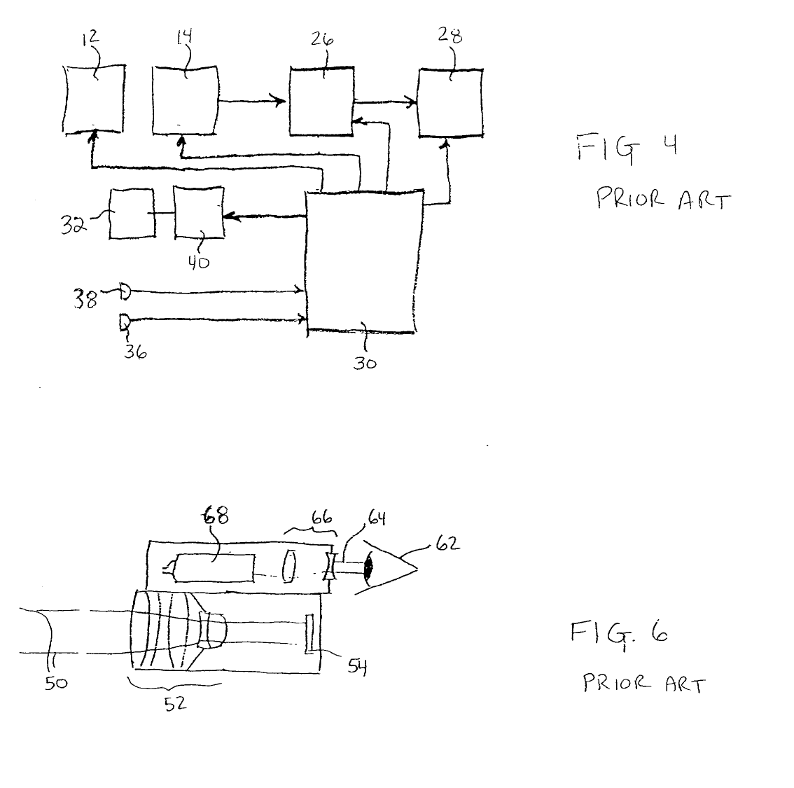

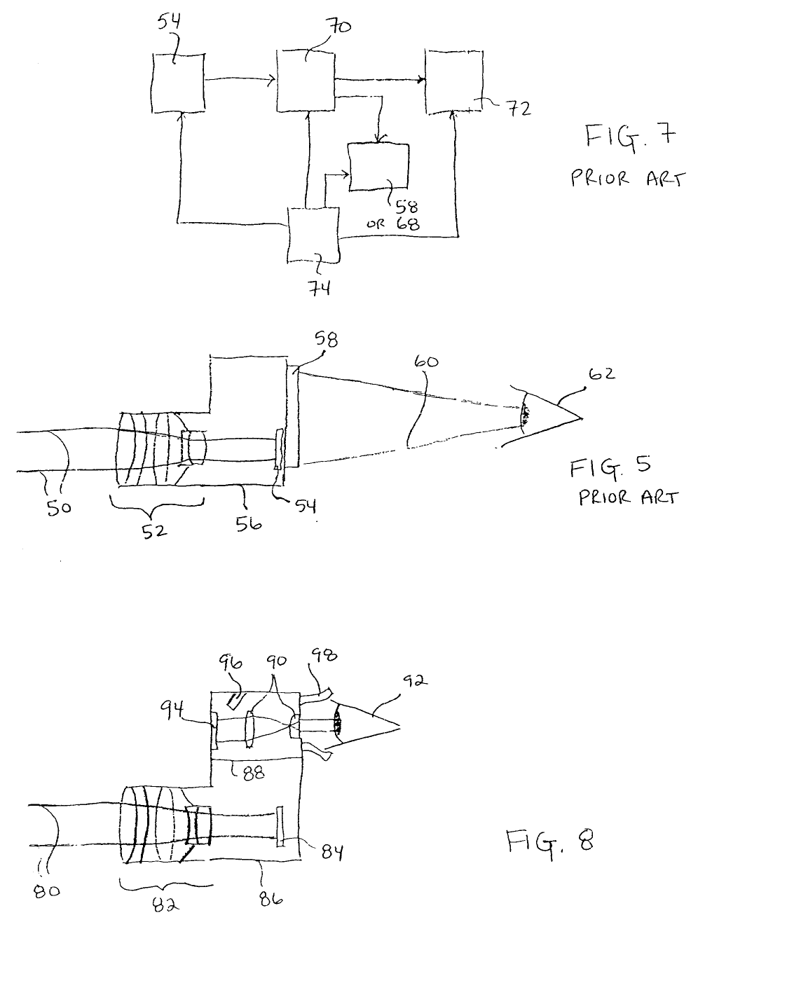

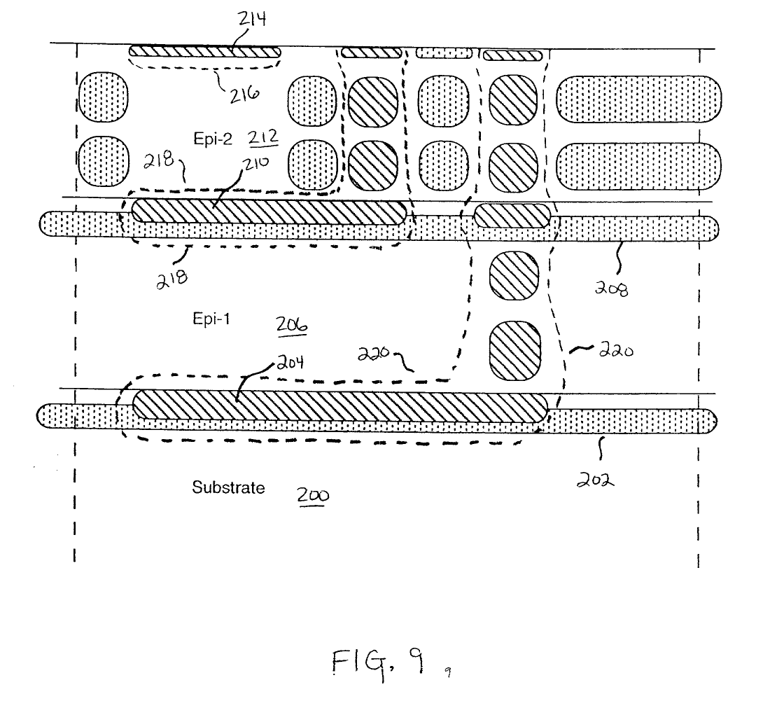

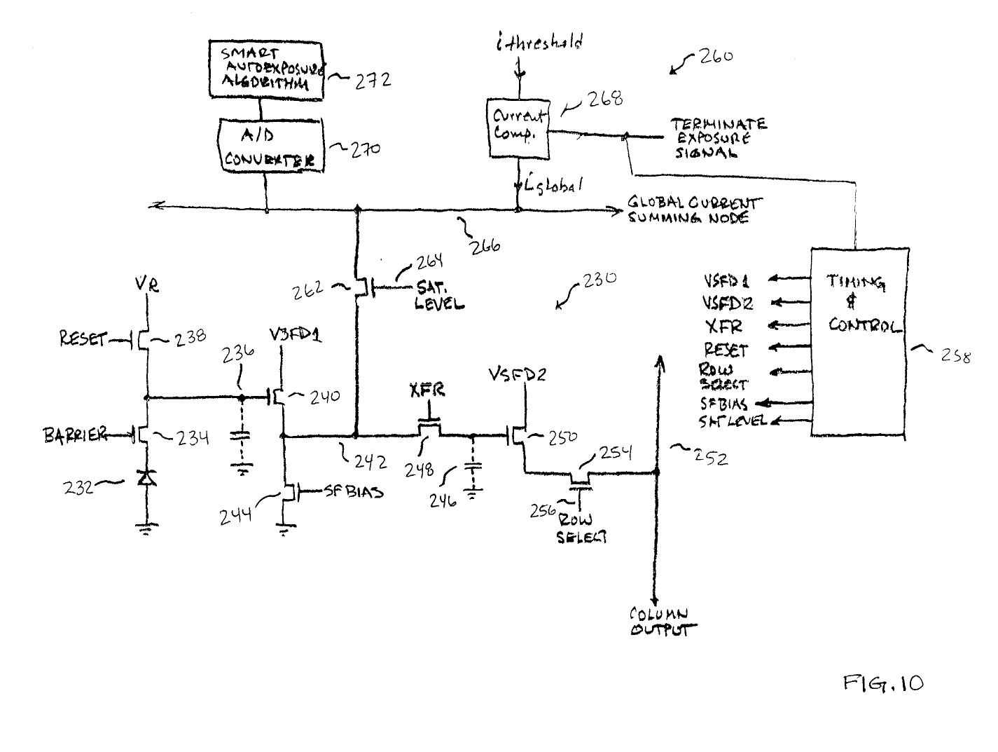

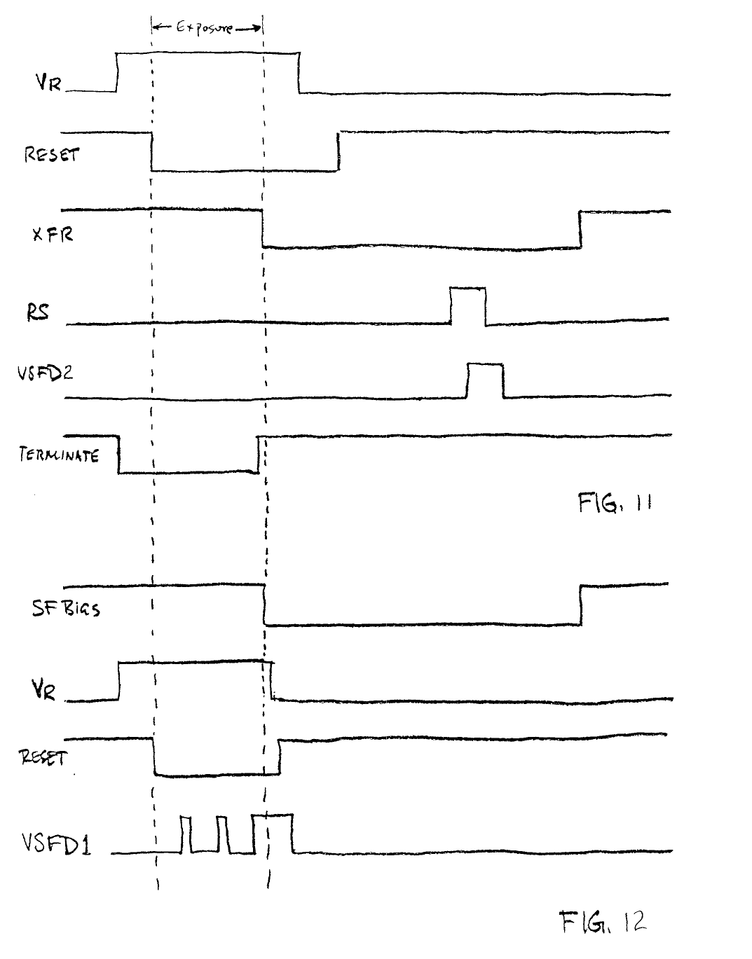

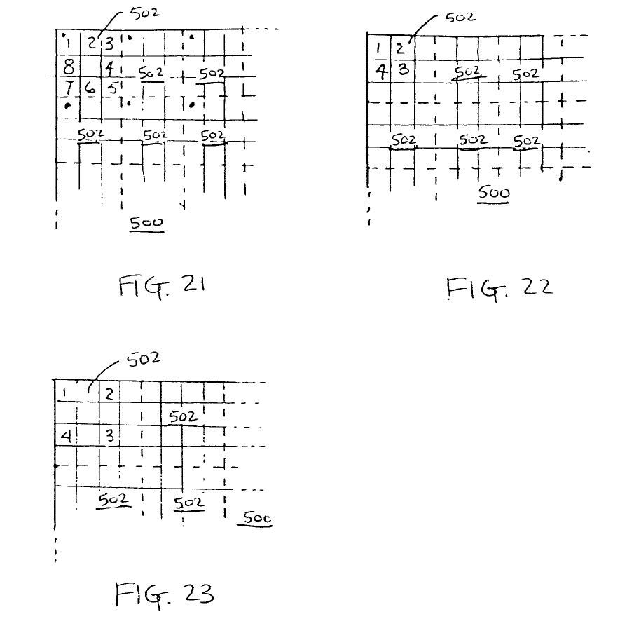

Preferred subsampling schemes result in the selection of pixels that are separated horizontally and vertically by the same prescribed distance so that the resulting change of scale in the horizontal and vertical directions is the same. FIGS. 21-23 illustrate examples of suitable subsampling schemes in which 1 out of 9 pixels is chosen from 3×3 pixel blocks 502 of FIGS. 21 and 22, and 1 out of 16 pixels is selected from 4×4 pixel block 502 in FIG. 23. In FIG. 21, the image is sampled sequentially, starting at pixel 1 of each 3×3 blocks 502 and then sequentially resampling, clockwise, each 3×3 block 502 of sequential image frames 500 for the remaining pixel positions 2-8. Because the sequence is periodic, the sequence repeats every 8 display frames. This causes the flicker rate to be ⅛ of the display frame rate (e.g. 1.5 to 3.75 Hz for frame rates of 12 to 30 frames per second). The sampling pattern of FIG. 23 sequences through four pixel positions (1-4) for each 3×3 block 502 in sequential frames 500 before repeating the sequence. This causes the flicker rate to be ¼ of the frame rate and typically results in flicker rates of 3 to 7.5 Hz. Similarly, the pattern illustrated in FIG. 23 samples 1 out of 16 pixels of each 4×4 block 502 for pixel positions 1-4 before repeating and thus produces a flicker rate equal to ¼ of the frame rate. The resulting flicker rate would typically be in the range of 3 to 7.5 Hz. The subsampling patterns that are preferred are periodic patterns of 4 or 8 different offsets generated in 3×3 or 4×4 pixel blocks, such that the offset moves in a 4 pixel small square pattern, or in an 8 pixel large square pattern. Although a clockwise subsampling sequence is used in FIGS. 21 and 22, it should be noted that a counterclockwise sequence or any sequence through the selected pixel positions can be used to produce the desired animation of aliased image components.

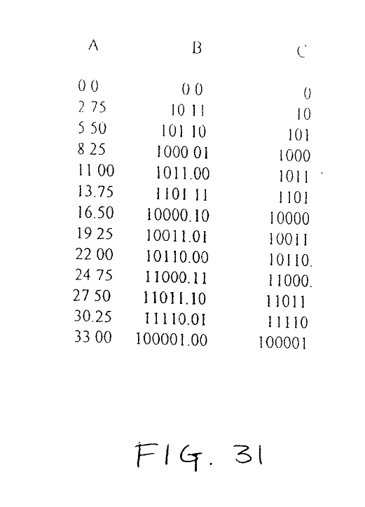

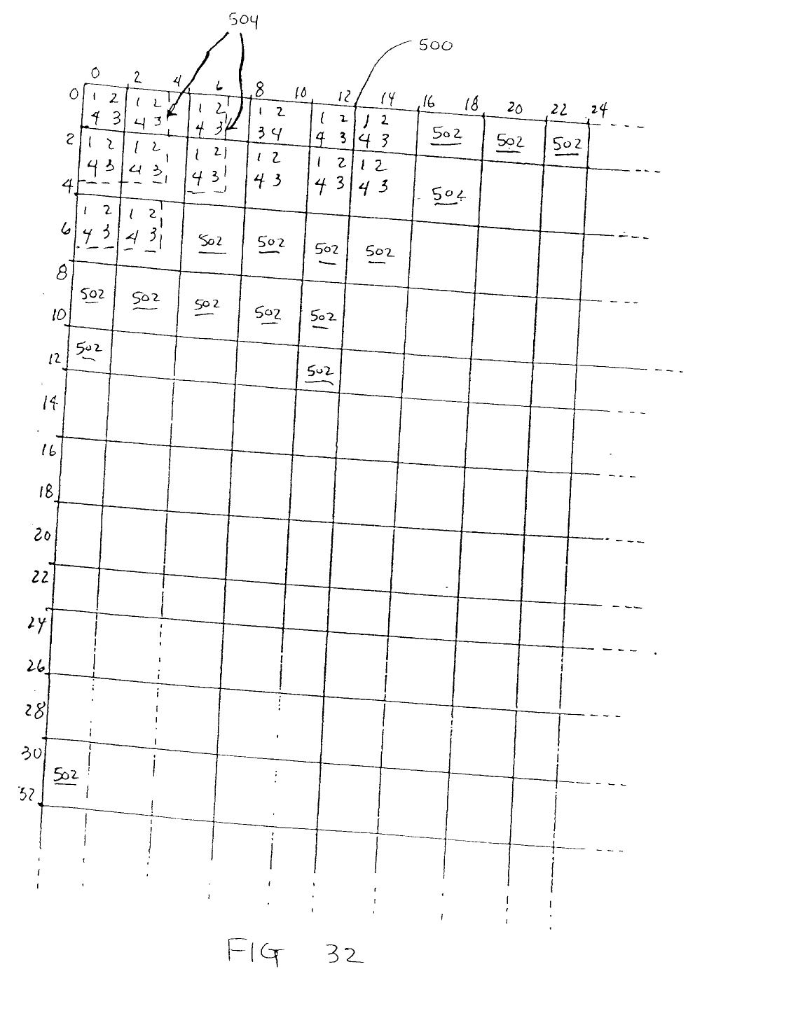

FIGS. 24-30 illustrate an example of a periodic image sequence produced by subsampling and as displayed on an electronic viewfinder. In FIG. 24, a portion of an image frame 500 is illustrated. Each full resolution frame 500 is to be subsampled using 3×3 pixel blocks 502. Pixel positions within each pixel block 502 that are to be used for creating four subsampled images are labeled 1 through 4. The shaded pixels represent a sharp brightness edge in the discrete sampled image created by the photocell array of a digital camera. A row and column coordinate, (r, c) respectively identifies each pixel block. If one pixel position (of 1-4) is used in every pixel block 502 of FIG. 24 to produce a reduced resolution image 503, a different image, with a 3-to-1 scale reduction, is created for each of the four pixel positions. Thus, FIGS. 25-28 respectively illustrate the subsampled images corresponding to sampling pixel positions 1 through 4. The indices for the rows and columns of FIGS. 25-28 corresponds to the pixel block coordinates of FIG. 24 from which the subsampled pixels were taken. If all four subsampled images of FIGS. 25-28 are sequentially displayed, the image in FIG. 29 would result and have a flicker rate of ¼ of the display frame rate. The relative jaggieness of the resulting image 505 in FIG. 29 is also increased because a discontinuity of one pixel in the scaled subsampled image corresponds to a 3 pixel discontinuity in the original image. The degree of shading in FIG. 29 indicates a variation in intensity due to the number of shaded pixels in the set of subsampled images that are superimposed. FIG. 30 illustrates the light-dark (or on-off) time history of selected pixels (0, 6), (0, 7), (1,2), and (1, 3) as a function of both frame intervals and sample pixel number from which it can be seen that a flicker period of four frame intervals is created.

The important visual feature that distinguishes this inventive viewfinder image from that of the prior art method of averaging of corresponding frames is the use of motion and flicker, which are readily apparent in image regions that are sharply focused.

The above descriptions were limited to specific examples for clarity of explanation of the embodiments. For example, subsampling, which was limited to scaling factors of 3-to-1 and 4-to-1 (or decimation factors of 9 and 16), may not be appropriate because specific differences between a digital camera resolution and the viewfinder resolution may require other scaling factors that can include non-integer reduction factors. However, the principles described above can be readily adapted to accommodate the general non-integer case.

For example, consider a non-integer resolution reduction factor of 2.75. Because fractional pixels do not exist in the full resolution image, the pixel array 500 of FIG. 24 can not be partitioned into 2.75×2.75 pixel blocks 502. FIG. 31 is a table that illustrates how the method is adapted for the non-integer case. Column A is a sequence of uniform horizontal and vertical pixel addresses (decimal) at which an edge of a pixel block would be located if fractional pixels could be used. Column B is the binary coded equivalent of column A. Column C is a truncated version of column B where the fractional part of the column B entries have been dropped so that an integer approximation of column B results. The average pixel block interval asymptotically approaches the desired non-integer interval as the size of the high-resolution image pixel array increases. Because of the substantially uniform subsampling interval, substantially uniform horizontal and vertical scaling of the image results.

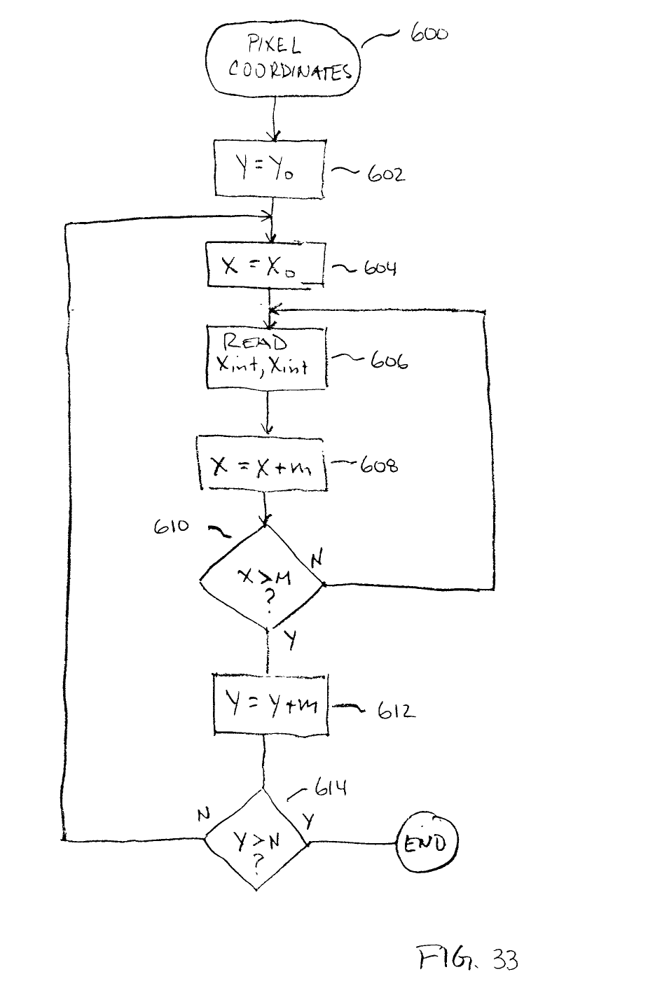

FIG. 32 illustrates the results of using the values of FIG. 31, column C. The full resolution image array is illustrated partitioned into 3×3, 3×2, 2×3, and 2×2 pixel blocks 502 in proper proportion to produce a subsampled image with an average decimation factor of 2.75×2.75. (If the values of column B were rounded before truncation, the distribution of pixel block sizes for large size image arrays would have been the same. Hence, the preferred implementation does not include rounding before truncation.)

The location of the pixels to be displayed within each pixel block should preferably be chosen so that all pixel locations will fit within all pixel blocks, including the smallest (2×2 for the example of FIG. 32). As a result, a closed cycle of displacement over a total displacement that is less than the smallest interval between samples. The number of pixel locations selected for sequential display determines the flicker rate. For example, in FIG. 32, four unique pixel locations are indicated for each pixel block so that the flicker rate is one-fourth of the frame display rate if each subsampled image corresponding to a selected unique pixel location is displayed once during a flicker period. The flicker period can be increased either by increasing the number of unique pixel locations or by sampling one or more of the unique pixel locations more than once during a flicker period.

Dashed line boundaries 504 in FIG. 32 illustrate that samples are still taken from equal-size square blocks, but that these blocks are no longer necessarily contiguous since they are sub-blocks of the unequal blocks 502.

FIG. 33 is the flow diagram of preferred method 600 for determining the coordinates (addresses) of the pixels that are required to achieve a given integer or non-integer resolution reduction factor, m. Step 602 sets initial sample coordinates Y=Y₀. Step 604 sets X=X₀. In step 606, the pixel value at coordinates Xᵢₙₜ, Yᵢₙₜ, where the subscript represents the floor function or integer part, is read from the high resolution image. In step 608, the next possibly non-integer horizontal address, is computed using its previous value and m. If, in step 610, it is determined that X does not exceed the horizontal pixel range, the process returns to step 606. Otherwise, step 612 is used to compute the next possibly non-integer row address, Y. If, in step 614, it is determined that Y is not greater than the row limit of the high-resolution limit, the process returns to step 606. Otherwise, the process ends and the subsampling is complete.

By repeating the process for a selected set of initial pixel locations (X₀, Y₀), method 700 can be used to generate a periodic sequence of reduced resolution images for display.

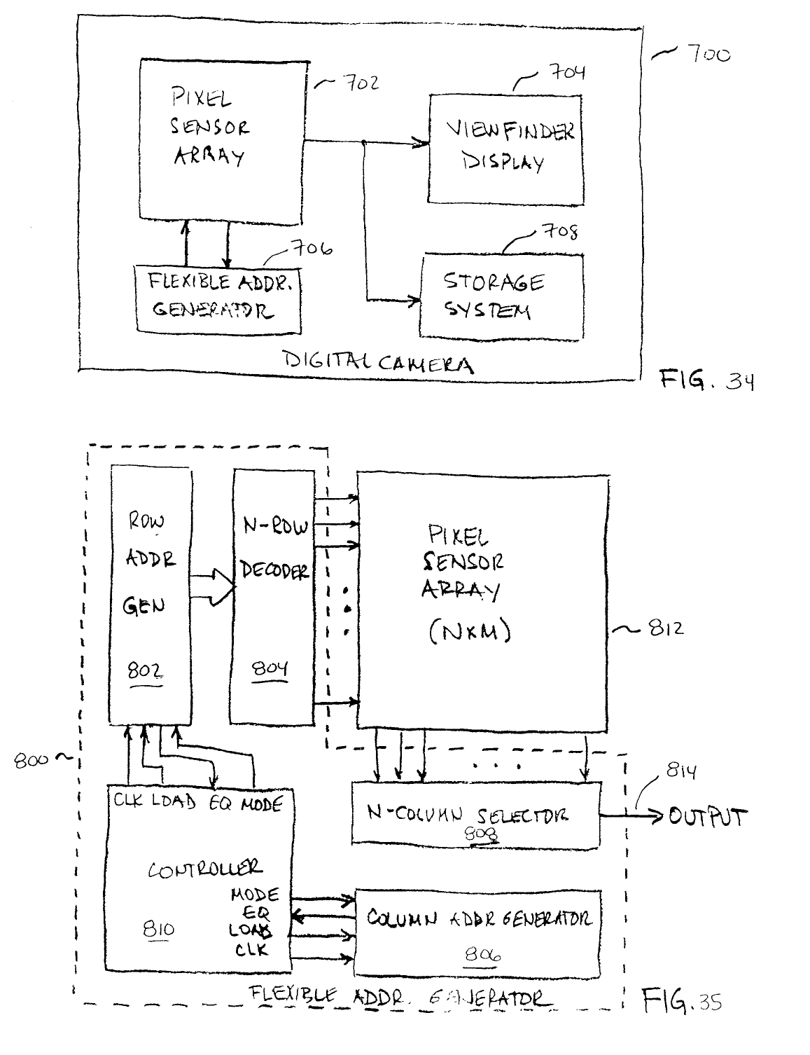

FIG. 34 is a block diagram of a digital camera 700 employing scanning circuitry for subsampling high resolution pixel sensor array 702 for display on lower resolution viewfinder display 704 that may be used in accordance with the methods disclosed herein. The addresses and control signals, generated by flexible address generator 706, provides all of the signals necessary to control the reading of pixel data out of pixel sensor array 702. Flexible address generator 706 is used to read the high-resolution image out of pixel sensor array 702 for storage in storage system 708. Also, flexible address generator 706 is used to subsample the high-resolution image generated by pixel sensor array 702 for display on viewfinder display 704 so that the captured image can be adjusted and focused at the reduced resolution display of viewfinder 704.

FIG. 35 is an illustrative block diagram illustrating in more detail the relationship between the flexible address generator and pixel sensor array of FIG. 34 with N rows and M columns. Flexible address generator 800 includes row address generator 802, row decoder 804, column address generator 806, column selector 808, and controller 810. Row address generator 802 and column address generator 806 are loadable counters under the control of controller 810. Controller 810 provides clock signals, counting interval (scale factor) m, and an initial offset address, (X₀,Y₀), to row and column address generators 802 and 806, and receives status signals from row and column address generators 802 and 806. The readout of a subsampled image from pixel sensor array 812 begins with the loading of the initial offset coordinates, (X₀,Y₀), as respective initial addresses to row address generator 802 and column address generator 806. The column address counter is then clocked to increment by m for producing the non-truncated coordinates, (X, Y) of which only the integer part bits are respectively supplied to row decoder 804 and column selector 808 for selecting the row and column of the pixel that is to be readout on output line 814 for display on viewfinder 704 of FIG. 34. When the last subsampled pixel of a given row is read out, the column address generator activates line EQ to indicate that the row has been subsampled. The counter of row address generator 802 is incremented by m for producing a next Y value, and the column address generator 806 is reset to X₀. The previously described operation for reading the selected columns is repeated. When the last row and column is readout, a scan-complete signal (EQ) is sent to controller 810 by row and column address generators 802 and 806. The controller produces a new subsampled image display by initializing the process with a new set of prescribed initial coordinate offsets.

Accordingly, a novel and useful all-electronic camera system has been described wherein true through-the-lens autofocus, autoexposure, viewfinding, and flash control are accomplished without moving parts within the camera body, and all quantities derived directly from information on the primary sensor chip.

While embodiments and applications of this invention have been illustrated and described, it would be apparent to those skilled in the art that many more modifications than mentioned above are possible without departing from the inventive concepts herein. The invention, therefore, is not to be restricted except in the spirit of the appended claims.

What is claimed is:

1. An electronic camera system comprising:
a lens system including at least one lens and having an optical axis and a focal plane;
a semiconductor sensor array located on said optical axis at said focal plane of said lens system, said semiconductor sensor array having a plurality of pixels, each of said pixels generating an output signal that is a function of light incident thereon;
a sensor control circuit coupled to said semiconductor sensor array and adapted to produce sensor control signals for controlling an operation of said pixels in said semiconductor sensor array in response to input from a user of said camera system;
an addressing circuit coupled to said semiconductor sensor array and configured to produce a first set of image output signals and a second set of image output signals from said semiconductor sensor array, said first set of image output signals being indicative of an intensity of said light at a first set of said pixels when said sensor control signals are in a first state, said second set of image output signals being indicative of an intensity of said light at a second set of said pixels when said sensor control signals are in a second state, said first set of pixels including more said pixels than said second set of pixels;
a storage medium adapted to store a representation of said first set of image output signals when said sensor control signals are in said first state; and
a display adapted for displaying said second set of image output signals when said sensor control signals are in said second state.

2. The electronic camera system of claim 1, wherein said first set of said pixels is a majority of said pixels in said array and said second set of pixels is a preset fraction of said pixels in said array that is less than half of a total of said pixels in said array.

3. The electronic camera system of claim 2, wherein:
said array is arranged as a plurality of rows and columns of pixels; and
said second set of pixels comprises pixels from not more than half of said rows and not more than half of said columns of said array.

4. The electronic camera system of claim 3, wherein not more than half of said rows includes every Nth row and not more than half of said columns includes every Nth column, wherein N is an integer greater than one.

5. The electronic camera system of claim 1, wherein said semiconductor sensor array is a CMOS sensor array.

6. The electronic camera system of claim 5, wherein said CMOS sensor array is a vertical color filter CMOS sensor array.

7. The electronic camera system of claim 1, wherein said storage medium is a semiconductor memory array.

8. The electronic camera system of claim 1, wherein said storage medium is a magnetic disk storage device.

9. The electronic camera system of claim 1, wherein said storage medium is an optical disk storage device.

10. An electronic camera system comprising:
a lens system including at least one lens and having an optical axis and a focal plane;
a semiconductor sensor array located on said optical axis at said focal plane of said lens system, said semiconductor sensor array having a plurality of pixels, each of said pixels generating an output signal that is a function of light incident thereon;
a sensor control circuit coupled to said semiconductor sensor array and adapted to produce sensor control signals for controlling an operation of said pixels in said semiconductor sensor array in response to input from an user of said camera system;
an addressing circuit coupled to said semiconductor sensor array and configured to produce a first set of image output signals and a second set of image output signals from said semiconductor sensor array, said first set of image output signals being indicative of an intensity of said light at a first set of said pixels when said sensor control signals are in a first state, said second set of image output signals being indicative of an intensity of said light at a second set of said pixels when said sensor control signals are in a second state, said first set of pixels including more pixels than said second set of pixels;
a storage medium adapted to store a representation of said first set of image output signals when said sensor control signals are in said first state; and
a display adapted for displaying said second set of image output signals when said sensor control signals are in said second state;
a means for computing focus signals indicating a quality of focus of said light from said image output signals when said sensor control signals are in said second state and for generating lens control signals in response to said focus signals; and
focusing control means in said lens system responsive to said lens control signals.

11. The electronic camera system of claim 10, wherein said first set of said pixels is a majority of said pixels in said array and said second set of pixels is a preset fraction of said pixels in said array that is less than half of a total of said pixels in said array.

12. The electronic camera system of claim 11, wherein:
said array is arranged as a plurality of rows and columns of pixels; and
said second set of pixels comprises pixels from not more than half of said rows and not more than half of said columns of said array.

13. The electronic camera system of claim 12, wherein not more than half of said rows includes every Nth row and not more than half of said columns includes every Nth column, wherein N is an integer greater than one.

14. The electronic camera system of claim 10, wherein said semiconductor sensor array is a CMOS sensor array.

15. The electronic camera system of claim 14, wherein said CMOS sensor array is a vertical color filter CMOS sensor array.

16. The electronic camera system of claim 10, wherein said storage medium is a semiconductor memory array.

17. The electronic camera system of claim 10, wherein said storage medium is a magnetic disk storage device.

18. The electronic camera system of claim 10, wherein said storage medium is an optical disk storage device.

19. An electronic camera system comprising:
a lens system including at least one lens and having an optical axis and a focal plane;
a semiconductor sensor array located on said optical axis at said focal plane of said lens system, said semiconductor sensor array having a plurality of pixels, each of said pixels generating an output signal that is a function of integration during an integration time of a signal that is a function of light incident thereon;
a sensor control circuit coupled to said semiconductor sensor array and adapted to produce sensor control signals for controlling an operation of said pixels in said semiconductor sensor array in response to input from a user of said camera system;
an addressing circuit coupled to said semiconductor sensor array and configured to produce a first set of image output signals and a second set of image output signals from said semiconductor sensor array, said first set of image output signals being indicative of an intensity of said light at a first set of said pixels when said sensor control signals are in a first state, said second set of image output signals being indicative of an intensity of said light at a second set of said pixels when said sensor control signals are in a second state, said first set of pixels including more pixels than said second set of pixels;
a storage medium adapted to store a representation of said first set of image output signals when said sensor control signals are in said first state; and
a display adapted for displaying said second set of image output signals when said sensor control signals are in said second state;
exposure detection means for generating an overall exposure signal indicating an aggregate state of exposure of said pixels during said integration time when said sensor control signals are in said first state; and
exposure control means for terminating said integration period in response to said overall exposure signal.

20. The electronic camera system of claim 19, further including a flash illumination source coupled to said sensor control circuit to be enabled in response to user input and disabled in response to said overall exposure signal.

21. The electronic camera system of claim 19, further including:
means for computing focus signals indicating a quality of focus of said light from said image output signals when said sensor control signals are in said second state and for generating lens control signals in response to said focus signals; and
focusing control means in said lens system responsive to said lens control signals.

22. The electronic camera system of claim 19, wherein said first set of said pixels is a majority of said pixels in said array and said second set of pixels is a preset fraction of said pixels in said array that is less than half of a total of said pixels in said array.

23. The electronic camera system of claim 22, wherein:
said array is arranged as a plurality of rows and columns of pixels; and
said second set of pixels comprises pixels from not more than half of said rows and not more than half of said columns of said array.

24. The electronic camera system of claim 23, wherein not more than half of said rows includes every Nth row and not more than half of said columns includes every Nth column, wherein N is an integer greater than one.

25. The electronic camera system of claim 19, wherein said semiconductor sensor array is a CMOS sensor array.

26. The electronic camera system of claim 25, wherein said CMOS sensor array is a vertical color filter CMOS sensor array.

27. The electronic camera system of claim 19, wherein said storage medium is a semiconductor memory array.

28. The electronic camera system of claim 19, wherein said storage medium is a magnetic disk storage device.

29. The electronic camera system of claim 19, wherein said storage medium is an optical disk storage device.

30. An electronic camera system, comprising:
a lens system including at least one lens;
a semiconductor sensor array optically coupled to said lens system, said semiconductor sensor array having a plurality of pixels arranged in a plurality of rows and columns, each of said pixels generating an output signal that is a function of light comprising an image incident thereon;
an addressing circuit associated with said semiconductor sensor array, said addressing circuit having a storage addressing mode for generating storage addressing signals to said semiconductor sensor array in which substantially all of said rows and columns of said pixels in said array are addressed and a display addressing mode for generating display addressing signals to said semiconductor sensor array in which substantially less than all of said rows and columns of said pixels in said array are addressed;
a sensor control circuit coupled to said semiconductor sensor array and to said addressing circuit and operable to produce sensor control signals and addressing circuit control signals for controlling an operation of said pixels in said semiconductor sensor array in response to input from an user of said camera system;
a storage medium coupled to said semiconductor sensor array and operable to store data representing an image sensed by said semiconductor sensor array and presented to said storage medium from said semiconductor sensor array in response to said storage addressing signals; and
a display coupled to said semiconductor sensor array and operable to display data representing an image sensed by said semiconductor sensor array and presented to said display from said semiconductor sensor array in response to said display addressing signals.

31. The electronic camera system of claim 30, wherein said addressing circuit addresses fewer than half of said rows and columns of said pixels in said array in said display addressing mode.

32. The electronic camera system of claim 30, wherein said addressing circuit addresses pixels from not more than half of said rows and not more than half of said columns of said array.

33. The electronic camera system of claim 32, wherein not more than half of said rows includes every Nth row and not more than half of said columns includes every Nth column, wherein N is an integer greater than one.

34. The electronic camera system of claim 33, wherein N is equal to 4.

35. The electronic camera system of claim 30, wherein said semiconductor sensor array is a CMOS sensor array.

36. The electronic camera system of claim 35, wherein said CMOS sensor array is a vertical color filter CMOS sensor array.

37. The electronic camera system of claim 30, wherein said storage medium is a semiconductor memory array.

38. The electronic camera system of claim 30, wherein said storage medium is a magnetic disk storage device.

39. The electronic camera system of claim 30, wherein said storage medium is an optical disk storage device.

40. An electronic camera system comprising:
a lens system including at least one lens;
a semiconductor sensor array optically coupled to said lens system, said semiconductor sensor array having a plurality of pixels arranged in a plurality of rows and columns, each of said pixels generating an output signal that is a function of light comprising an image incident thereon;
an addressing circuit associated with said semiconductor sensor array, said addressing circuit having a storage addressing mode for generating storage addressing signals to said semiconductor sensor array in which substantially all of said rows and columns of said pixels in said array are addressed and a display addressing mode for generating display addressing signals to said semiconductor sensor array in which substantially less than all of said rows and columns of said pixels in said array are addressed;
a sensor control circuit coupled to said semiconductor sensor array and to said addressing circuit and operable to produce sensor control signals and addressing circuit control signals for controlling an operation of said pixels in said semiconductor sensor array in response to input from an user of said camera system;
a storage medium coupled to said semiconductor sensor array and operable to store data representing an image sensed by said semiconductor sensor array and presented to said storage medium from said semiconductor sensor array in response to said storage addressing signals;
a display coupled to said semiconductor sensor array and operable to present display data representing an image sensed by said semiconductor sensor array and presented to said display from said semiconductor sensor array in response to said display addressing signals;
a focus-signal computing circuit configured to receive said display data from said semiconductor sensor array in response to said display addressing signals and to compute focus signals indicating a quality of focus of said image and for generating lens control signals in response to said focus signals; and
focusing control apparatus in said lens system coupled to and responsive to said lens control signals.

41. The electronic camera system of claim 40, wherein said addressing circuit addresses fewer than half of said rows and columns of said pixels in said array in said display addressing mode.

42. The electronic camera system of claim 40, wherein said addressing circuit addresses pixels from not more than half of said rows and no t more than half of said columns of said array in said display addressing mode.

43. The electronic camera system of claim 42, wherein not more than half of said rows includes every Nth row and not more than half of said columns includes every Nth column, wherein N is an integer greater than one.

44. The electronic camera system of claim 43, wherein N is equal to 4.

45. The electronic camera system of claim 32, wherein said semiconductor sensor array is a CMOS sensor array.

46. The electronic camera system of claim 45, wherein said CMOS sensor array is a vertical color filter CMOS sensor array.

47. The electronic camera system of claim 40, wherein said storage medium is a semiconductor memory array.

48. The electronic camera system of claim 40, wherein said storage medium is a magnetic disk storage device.

49. The electronic camera system of claim 40, wherein said storage medium is an optical disk storage device.

50. An electronic camera system comprising:
a lens system including at least one lens;
a semiconductor sensor array optically coupled to said lens system, said semiconductor sensor array having a plurality of pixels arranged in a plurality of rows and columns, each of said pixels generating an output signal that is a function of integration during an integration time of a signal that is a function of light comprising an image incident thereon;
an addressing circuit associated with said semiconductor sensor array, said addressing circuit having a storage addressing mode for generating storage addressing signals to said semiconductor sensor array in which substantially all of said rows and columns of said pixels in said array are addressed and a display addressing mode for generating display addressing signals to said semiconductor sensor array in which substantially less than all of said rows and columns of said pixels in said array are addressed;
a sensor control circuit coupled to said semiconductor sensor array and to said addressing circuit and operable to produce sensor control signals and addressing circuit control signals for controlling an operation of said pixels in said semiconductor sensor array in response to input from an user of said camera system;
a storage medium coupled to said semiconductor sensor array and operable to store data representing an image sensed by said semiconductor sensor array and presented to said storage medium from said semiconductor sensor array in response to said storage addressing signals;
a display coupled to said semiconductor sensor array and operable to present display data representing an image sensed by said semiconductor sensor array and presented to said display from said semiconductor sensor array in response to said display addressing signals.
said semiconductor sensor array configured to generate an overall exposure signal indicating an aggregate state of exposure of said pixels during said integration time and including an exposure control circuit for terminating said integration period in response to said overall exposure signal.

51. The electronic camera system of claim 50, further including a flash illumination source coupled to said sensor control circuit to be enabled in response to user input and disabled in response to said overall exposure signal.

52. The electronic camera system of claim 50, further including:
a focus-signal computing circuit configured to receive said display data from said semiconductor sensor array in response to said display addressing signals and to compute focus signals indicating a quality of focus of said image and for generating lens control signals in response to said focus signals; and
focusing control apparatus in said lens system coupled to and responsive to said lens control signals.

53. The electronic camera system of claim 50, wherein said addressing circuit addresses fewer than half of said rows and columns of said pixels in said array in said display addressing mode.

54. The electronic camera system of claim 50, wherein said addressing circuit addresses pixels from not more than half of said rows and not more than half of said columns of said array in said display addressing mode.

55. The electronic camera system of claim 54, wherein not more than half of said rows includes every Nth row and not more than half of said columns includes every Nth column, wherein N is an integer greater than one.

56. The electronic camera system of claim 55, wherein N is equal to 4.

57. The electronic camera system of claim 50, wherein said semiconductor sensor array is a CMOS sensor array.

58. The electronic camera system of claim 57, wherein said CMOS sensor array is a vertical color filter CMOS sensor array.

59. The electronic camera system of claim 50, wherein said storage medium is a semiconductor memory array.

60. The electronic camera system of claim 50, wherein said storage medium is a magnetic disk storage device.

61. The electronic camera system of claim 50, wherein said storage medium is an optical disk storage device.

62. A method for operating an electronic camera comprising:
placing an image on a semiconductor sensor array having a plurality of rows and columns of pixel sensors disposed thereon;
addressing a first group of said pixels on said semiconductor sensor array, said first group of pixels comprising substantially less than all of said rows and columns of said pixels in said array, to obtain display data;
displaying said display data on a display associated with said electronic camera;
sensing an image-capture request made by a user; and
addressing a second group of said pixels on said semiconductor sensor array, said second group of pixels comprising substantially all of said rows and columns of said pixels in said array to obtain image-storage data, and storing said image-storage data in a storage medium associated with said electronic camera data in response to said image-capture request.

63. The method of claim 62, wherein:
addressing said first group of said pixels on said semiconductor sensor array comprises addressing selected ones of said rows and columns of said pixels on said semiconductor sensor array; and
addressing said second group of said pixels on said semiconductor sensor array comprises addressing substantially all of said rows and columns of said pixels on said semiconductor sensor array.

64. The method of claim 63, wherein addressing selected ones of said rows and columns of said pixels on said semiconductor sensor array comprises addressing pixels comprises pixels from not more than half of said rows and not more than half of said columns of said array in said display addressing mode.

65. The method of claim 64, wherein not more than half of said rows includes every Nth row and not more than half of said columns includes every Nth column, wherein N is an integer greater than one.

66. The method of claim 65, wherein N is equal to 4.

67. The method of claim 62, further including;
computing a focus metric from said display data; and
adjusting a focus of said image on said semiconductor sensor array in response to said focus metric.

68. The method of claim 62, further including:
setting said pixels in said array to a known state and then integrating signals on said pixels in said array during an integration time, said signals being a function of a light received by said pixels in response to said image-capture request;
generating an overall exposure signal indicating an aggregate state of exposure of said pixels during said integration time; and
terminating said integration period in response to said overall exposure signal.

69. The method of claim 68, further including:
initiating flash illumination from a flash illumination source associated with said electronic camera in response to said image-capture request; and
terminating said flash illumination in response to said overall exposure signal.
